(19) United States
(12) Patent Application Publication
(10) Pub. No.: US 2022/0264598 A1
(43) Pub. Date: Aug. 18, 2022

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Weijie XU, Dongguan (CN); Yanan LIN, Dongguan (CN); Jing XU, Dongguan (CN)

(21) Appl. No.: 17/588,731

(22) Filed: Jan. 31, 2022

Related U.S. Application Data
(63) Continuation of application No. PCT/CN2019/099868, filed on Aug. 8, 2019.

(51) Int. Cl. H04W 72/12; H04W 72/04; H04W 72/14

(52) U.S. Cl. CPC H04W 72/1263; H04W 72/14; H04W 72/042; H04W 72/0446

(57) ABSTRACT

Provided are a wireless communication method and device, wherein same can reduce the cost of a terminal device without affecting the transmission performance of the terminal device. The method comprises: a terminal device receiving slot configuration information sent by a network device, wherein the slot configuration information is used for indicating at least one of a flexible slot or symbol, an uplink slot or symbol, and a downlink slot or symbol; the flexible slot or symbol is not used by the terminal device to perform multiple uplink transmissions, and/or the flexible slot or symbol is not used by the terminal device to perform multiple downlink transmissions; and the multiple uplink transmissions are the same uplink transmissions, and the multiple downlink transmissions are the same downlink transmissions.

### CROSS REFERENCE TO RELATED APPLICATION

This application is a continuation of an International Application No. PCT/CN2019/099868, filed on Aug. 8, 2019, entitled “WIRELESS COMMUNICATION METHOD AND DEVICE”, the contents of which are incorporated herein by reference in its entirety.

### TECHNICAL FIELD

The embodiments of the present application relate to the field of communication technology, and more particularly, to a wireless communication method and a wireless communication device.

### BACKGROUND

At present, terminal devices need to support at least two receiving channels, and the terminal devices on some frequency bands need to support four receiving channels. The receiving channel includes components such as a receiving antenna, a filter, a power amplifier, and a sampler, etc. Therefore, the cost of the terminal device can be significantly reduced by reducing the number of radio frequency channels.

However, after the number of the radio frequency channels of the terminal device is reduced, a transmission performance of the terminal device will be affected.

For example, after the number of receiving antennas of the terminal device is reduced from two to one, the reception of a downlink channel will lose about 3 dB. Therefore, how to ensure the transmission performance of the terminal device while controlling the cost of the terminal device has become an urgent issue to be solved.

### SUMMARY

The embodiments of the present application provide a wireless communication method and a wireless communication device, which can reduce the cost of the terminal device without affecting a transmission performance of the terminal device.

In a first aspect, a wireless communication method comprises: a terminal device receiving a slot configuration information sent by a network device, wherein the slot configuration information is used to indicate at least one of a flexible slot or symbol, an uplink slot or symbol, and a downlink slot or symbol; wherein the flexible slot or symbol is not used by the terminal device to perform multiple uplink transmissions, and/or the flexible slot or symbol is not used by the terminal device to perform multiple downlink transmissions; and the multiple uplink transmissions are same uplink transmissions, and the multiple downlink transmissions are same downlink transmissions.

In a second aspect, a wireless communication method comprises: a terminal device receiving a slot configuration information sent by a network device, wherein the slot configuration information is used to indicate at least one of a flexible slot or symbol, an uplink slot or symbol, and a downlink slot or symbol; the terminal device receiving a first indication information sent by the network device, wherein the first indication information is used to indicate a set of available slots or symbols, and the set of available slots or symbols comprises an available flexible slot or symbol; the terminal device performing multiple uplink transmissions in a target uplink slot or symbol and the available flexible slot or symbol, and/or the terminal device performing multiple downlink transmissions in a target downlink slot or symbol and the available flexible slot or symbol; wherein the target uplink slot or symbol is part or all of the uplink slot or symbol indicated by the slot configuration information, the target downlink slot or symbol is part or all of the downlink slot or symbol indicated by the slot configuration information, the multiple uplink transmissions are same uplink transmissions, and the multiple downlink transmissions are same downlink transmissions.

In a third aspect, a wireless communication method comprises: a network device sending a slot configuration information to a terminal device, wherein the slot configuration information is used to indicate at least one of a flexible slot or symbol, an uplink slot or symbol, and a downlink slot or symbol; wherein the flexible slot or symbol is not used by the terminal device to perform multiple uplink transmissions, and/or the flexible slot or symbol is not used by the terminal device to perform multiple downlink transmissions; and the multiple uplink transmissions are same uplink transmissions, and the multiple downlink transmissions are same downlink transmissions.

In a fourth aspect, a wireless communication method, comprises: a network device sending a slot configuration information to a terminal device, wherein the slot configuration information is used to indicate at least one of a flexible slot or symbol, an uplink slot or symbol, and a downlink slot or symbol; the network device sending a first indication information to the terminal device, wherein the first indication information is used to indicate a set of available slots or symbols, and the set of available slots or symbols comprises an available flexible slot or symbol; the network device performing multiple uplink transmissions in a target uplink slot or symbol and the available flexible slot or symbol indicated by the slot configuration information, and/or the network device performing multiple downlink transmissions in a target downlink slot or symbol and the available flexible slot or symbol indicated by the slot configuration information, wherein the target uplink slot or symbol is part or all of the uplink slot or symbol indicated by the slot configuration information, the target downlink slot or symbol is part or all of the downlink slot or symbol indicated by the slot configuration information, wherein the multiple uplink transmissions are same uplink transmissions, and the multiple downlink transmissions are same downlink transmissions.

In a fifth aspect, a terminal device is provided to perform the method in any one of the above-mentioned first aspect to the second aspect or each implementation manner thereof.

In details, the terminal device includes a functional module to perform the method in any one of the above-mentioned first aspect to the second aspect or each implementation manner thereof.

In a sixth aspect, a network device is provided to perform the method in any one of the above-mentioned third aspect to the fourth aspect or each implementation manner thereof.

In details, the network device includes a functional module to perform any one of the third aspect to the fourth aspect or the method in each implementation manner thereof.

In a seventh aspect, a terminal device comprises a processor and a memory. The memory is used to store a computer program, and the processor is configured to call and run the computer program stored in the memory to perform the method in any one of the above-mentioned first aspect to the second aspect or each implementation manner thereof.

In an eighth aspect, a network device comprises a processor and a memory, wherein the memory is used to store a computer program, and the processor is configured to call and run the computer program stored in the memory to perform the method in any one of the above-mentioned third aspect to the fourth aspect or each implementation manner thereof.

In a ninth aspect, a device is provided to perform the method in any one of the above-mentioned first aspect to the fourth aspect or each implementation manner thereof.

In details, the device comprises a processor for calling and running a computer program from a memory, so that an equipment installed with the device performs the method in any one of the above-mentioned first aspect to the fourth aspect or each implementation manner thereof.

In a tenth aspect, a computer-readable storage medium is used for storing a computer program, the computer program causes a computer to perform the method in any one of the above-mentioned first aspect to the fourth aspect or each implementation manner thereof.

In an eleventh aspect, a computer program product comprises a computer program instruction, the computer program instruction causes a computer to perform the method in any one of the above-mentioned first aspect to the fourth aspect or each implementation manner thereof.

In a twelfth aspect, a computer program is provided, when the computer program runs on a computer, causes the computer to perform the method of any one of the above-mentioned first to fourth aspects or the implementations thereof.

In the technical solution provided by the present application, the terminal device can improve a transmission performance of the terminal device by repeating the transmission. In addition, when the terminal device performs an uplink transmission, the terminal device only performs the uplink transmission in an uplink slot or uplink symbol configured by the network device. That is to say, even if the slot structure configured by the network device includes a flexible slot or symbol, the terminal device does not perform the uplink transmission in the flexible slot or symbol. When the terminal device performs a downlink transmission, the terminal device only performs the downlink transmission in a downlink slot or symbol configured by the network device. That is to say, even if the slot structure configured by the network device includes a flexible slot or symbol, the terminal device does not perform the downlink transmission in the flexible slot or symbol. In this way, the repeated transmission of the terminal device does not occupy the flexible slot or symbol, so that the transmission of other terminal device will not be affected.

### BRIEF DESCRIPTION OF THE DRAWINGS

FIG. 1 is a schematic diagram of a wireless communication system to which an embodiment of the present application is applied.

FIG. 2 is a schematic diagram of a slot structure configured by a network device according to an embodiment of the present application.

FIG. 3 is a schematic diagram of another slot structure configured by a network device according to an embodiment of the present application.

FIG. 4 is a schematic diagram of another slot structure configured by a network device according to an embodiment of the present application.

FIG. 5 is a schematic diagram of still another slot structure configured by a network device according to an embodiment of the present application.

FIG. 6 is a schematic flowchart of a wireless communication method according to an embodiment of the present application.

FIG. 7 is a schematic flowchart of another wireless communication method according to an embodiment of the present application.

FIG. 8 is a schematic block diagram of a terminal device according to an embodiment of the present application.

FIG. 9 is a schematic block diagram of another terminal device according to an embodiment of the present application.

FIG. 10 is a schematic block diagram of a network device according to an embodiment of the present application.

FIG. 11 is a schematic block diagram of another network device according to an embodiment of the present application.

FIG. 12 is a schematic structural diagram of a communication device according to an embodiment of the present application.

FIG. 13 is a schematic structural diagram of a devices according to an embodiment of the present application.

FIG. 14 is a schematic block diagram of a communication system according to an embodiment of the present application.

### DETAILED DESCRIPTION OF ILLUSTRATED EMBODIMENTS

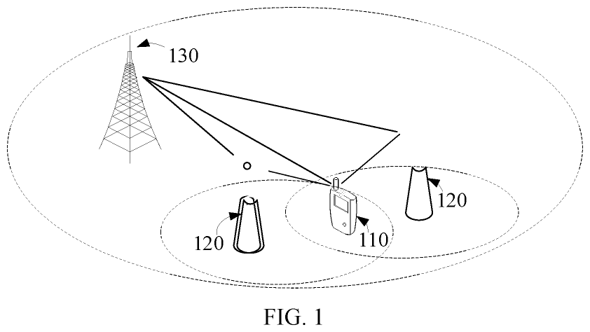

FIG. 1 is a schematic diagram of a system 100 according to an embodiment of the present disclosure.

As illustrated in FIG. 1, a terminal device 110 is connected to a first network device 130 in a first communication system and a second network device 120 in a second communication system.

For example, the first network device 130 is a network device in a long term evolution (LTE), and the second network device 120 is a network device in a new radio (NR).

There are multiple cells under the first network device 130 and the second network device 120.

It should be understood that FIG. 1 is an example of a communication system according to an embodiment of the present disclosure, and the embodiment of the present disclosure is not limited to that illustrated in FIG. 1.

As an example, the communication system to which the embodiment of the present disclosure is adapted may include at least multiple network devices under the first communication system and/or multiple network devices under the second communication system.

For example, the system 100 illustrated in FIG. 1 may include one main network device under the first communication system and at least one secondary network device under the second communication system. At least one secondary network device is respectively connected to the one main network device to form multiple connections and is respectively connected to the terminal device 110 to provide services for it. In details, the terminal device 110 may simultaneously establish a connection through the main network device and the secondary network device.

Optionally, a connection established between the terminal device 110 and the main network device is a main connection, and a connection established between the terminal device 110 and the secondary network device is a secondary connection. A control signaling of the terminal device 110 may be transmitted through the main connection, while data of the terminal device 110 may be transmitted through the main connection and the secondary connection simultaneously or may be transmitted only through the secondary connection.

As another example, the first communication system and the second communication system in the embodiments of the present disclosure are different, but the specific type of the first communication system and the second communication system is not limited.

For example, the first communication system and the second communication system may be various communication systems, such as: a global system of mobile communication (GSM) system, a code division multiple access (CDMA) system, a wideband code division multiple access (WCDMA) system, a general packet radio service (GPRS), a long term evolution (LTE) system, a LTE time division duplex (TDD), and an universal mobile telecommunication system (UMTS), etc.

The main network device and the secondary network device may be any access network device.

According to some implementations, in some embodiments, the access network device may be a base station (base transceiver station, BTS) in the global system of mobile communication (GSM) system or the code division multiple access (CDMA), a base station (NodeB, NB) in the wideband code division multiple access (WCDMA) system, or an evolutional base station (evolutional node B, eNB or eNodeB) in the long term evolution (LTE) system.

According to some implementations, the access network device may also be a next generation radio access network (NG RAN), a base station (gNB) in an NR system, or a wireless controller in a cloud radio access network (CRAN). Or, the access network device can be a relay station, an access point, an in-vehicle device, a wearable device, or a network device in a future-evolutional public land mobile network (PLMN), etc.

In the system 100 illustrated in FIG. 1, the first network device 130 being a main network device and the second network device 120 being a secondary network device are taken as an example.

The first network device 130 may be an LTE network device, and the second network device 120 may be an NR network device. Alternatively, the first network device 130 may be an NR network device, and the second network device 120 may be an LTE network device. Alternatively, both the first network device 130 and the second network device 120 may be an NR network device. Alternatively, the first network device 130 may be a GSM network device, a CDMA network device, etc., and the second network device 120 may also be a GSM network device, a CDMA network device, etc. Alternatively, the first network device 130 may be a macrocell, and the second network device 120 may be a microcell, picocell, femtocell, or the like.

According to some implementations, the terminal device 110 may be any terminal device, and the terminal device 110 includes but is not limited to:

an apparatus that is configured to receive or send communication signals via wired line connections, such as via public switched telephone networks (PSTN), digital subscriber lines (DSL), digital cables, direct cable connections and/or another data connections/networks; and/or via wireless interfaces, such as wireless interfaces configured for cellular networks, wireless local area networks (WLAN), like digital TV network of DVB-H networks, satellite networks, AM-FM broadcast transmitters and/or another terminal and/or Internet of Things (IoT) device. A terminal set to communicate via a wireless interface may be referred to as a “wireless communication terminal”, a “wireless terminal” or a “mobile terminal”. Examples of mobile terminals include but are not limited to satellites or cellular phones; personal communications system (PCS) terminals that can combine cellular radio phones with data processing, fax, and data communication capabilities; PDA that includes radio phones, pagers, Internet/intranet access, Web browser, memo pad, calendar, and/or global positioning system (GPS) receiver; and conventional laptop and/or palmtop receivers or other electronic apparatuses including radio telephone transceivers. The terminal may refer to access terminals, user equipment (UE), user units, user stations, mobile stations, mobile platforms, remote stations, remote terminals, mobile device, user terminals, terminals, wireless communication device, user agents or user apparatuses. The access terminal may be cellular phones, cordless phones, Session initiation protocol (SIP) phones, Wireless local loop (WLL) stations, personal digital assistants (PDA), handheld devices with wireless communication functions, computing devices or other processing devices connected to wireless modems, in-vehicle devices, wearable devices, terminals in 5G networks, or terminals in the future enhanced PLMN, etc.

It should be understood that the terms “system” and “network” in the present disclosure are often used interchangeably in the present disclosure.

With the continuous evolution and assistance of wireless communication technology, Internet of Things (IoT) technology is developing rapidly.

For example, 3rd generation partnership project (3GPP) organization promotes the development of machine type communication (MTC)/enhance MTC (eMTC) and IoT series standards have become candidate technology standards for the 5G massive MTC technology. These technical standards are expected to play a huge role in all aspects of people's production and life, such as smart homes, smart cities, smart factories, remote monitoring, and smart transportation.

Compared with non-IoT devices, IoT devices can have one or more of the following characteristics: 1) narrower bandwidth; 2) fewer antennas; 3) supporting lower data transmission rates; 4) lower maximum transmit power.

The IoT device in an embodiment of the present application may be, for example, at least one of the followings: an Internet of Things (IoT) device, an MTC device and an eMTC device.

Non-IoT devices may refer to terminal devices that have relatively high requirements for transmission delay and/or transmission rate.

For example, non-IoT devices may include enhanced mobile broadband (eMBB) devices. Alternatively, non-IoT devices may include ultra reliable low latency communication (URLLC) devices.

IoT terminals have the advantages of low cost, low price, support for ultra-low power consumption, and support for deep and wide coverage scenarios, which are conducive to a rapid popularization of IoT technology in an early stage of development. However, these devices have limitations in some application scenarios. Because a design goal of the MTC/eMTC deice and the IoT device is to support some applications with low data rate and high transmission delay, for some IoT scenarios that require relatively high rates, such as a video surveillance in an intelligent security and industrial applications requiring relatively low latency, it cannot be applied. However, if the terminal device with high transmission rate and low transmission delay is directly used, it will far exceed actual requirements of these scenarios and increase unnecessary costs. Therefore, an IoT-type device that supports a medium transmission rate, a medium delay requirement, and a medium-low bandwidth is proposed, for example, an IoT device that can support a 10 MHz bandwidth and a transmission rate of 100 Mbps.

Therefore, in order to improve the terminal system of the 5G massive MTC scenario, it is necessary to design a terminal type of NR MTC that medium transmission rate, medium delay requirement, and low cost.

Taking NR as an example, at present, NR terminals need to support at least 2 receiving channels, and NR terminals on certain frequency bands need to support 4 receiving channels. Each receiving channel needs to include components such as a receiving antenna, a filter, a power amplifier, and a sampler. Therefore, the cost of the terminal can be significantly reduced by reducing the number of radio frequency channels that the NR terminal needs to be equipped with. Some research results show that the cost of a chip module can be reduced by about ⅓ by reducing the two radio frequency channels of the terminal device to one radio frequency channel.

Therefore, embodiments of the present application can reduce the cost of the terminal device by reducing the number of radio frequency channels, where the radio frequency channels may include transmitting channels and/or receiving channels.

Although reducing the number of radio frequency channels can effectively reduce the cost of terminal device. However, due to the reduction of the number of receiving antennas, a receiving performance of the terminal device will also be affected, and a downlink coverage will be further affected. In addition, due to the reduction of the number of transmitting antennas, a transmission performance of the terminal device will also be affected, and an uplink coverage will be further affected.

For example, the number of receiving antennas of the terminal device is reduced by half, e.g., from two receiving antennas to one receiving antenna. Then, the reception of the downlink channel will lose about 3 dB. Therefore, in order to compensate for the impact of the reduction in the number of radio frequency channels on the uplink and downlink coverage, a signal transmission mechanism needs to be designed to compensate and restore the loss of the downlink coverage.

On the other hand, in some scenarios, such as industrial monitoring scenarios, the communication module may be placed in an area blocked by a metal object (such as a robotic arm). In this case, a network signal will be further lost. For this kind of work scenario, it is also necessary to design coverage enhancement schemes to make up for the performance loss.

Repeated transmission is a more typical and effective scheme to enhance coverage. For example, in theory, two repeated transmissions can bring a combined gain of 3 dB relative to a single repeated transmission; ten repeated transmissions can bring a combined gain of 10 dB.

Repeated transmission in this embodiment of the present application may refer to repeating transmission of the same signal multiple times. The specific transmission times can be configured through the network device. In different transmission times, a redundancy version (RV) of the same signal may be the same or different.

Currently, NR supports multi-slot physical downlink shared channel (PDSCH) and multi-slot physical uplink shared channel (PUSCH) transmission schemes. This is used to improve a transmission performance of PDSCH and PUSCH and enhance a signal coverage.

Multi-slot transmission means that a terminal device can repeatedly transmit uplink signals in multiple slots, or repeatedly receive downlink signals in multiple slots.

The following description will be given in conjunction with specific situations.

Taking PDSCH as an example, when a terminal device is configured with a downlink aggregation factor (aggregationFactorDL), where aggregationFactorDL>1, it means that PD SCH transmission can be applied to aggregationFactorDL slots. A transmission block (TB) transmitted by the terminal device is repeated in the aggregationFactorDL slots, and further, the transmission of PDSCH is limited to a single multiple-input multiple-output MIMO) layer transmission. The redundancy version of the nth transmitted TB block in the repeated transmission can be determined based on Table 1 below, where n≥1.

It should be noted that, the redundancy version of the TB block in the embodiment of the present application is not limited to be determined according to Table 1, and may also be determined in other manners.

The PDSCH in this embodiment of the present application may be scheduled through a downlink control information (DCI).

TABLE 1

| RV identifier | | | | |
|---|---|---|---|---|
| indicated | | | | |
| by PDSCH | RV identifier used in the nth transmission occasion | | | |
| scheduled | n mod | n mod | n mod | n mod |
| by DCI | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

In Table 1, “mod” represents a modulo operation.

It can be obtained from Table 1 that the DCI for scheduling PDSCH sent by the network device to the terminal device may carry the RV identifier. When the network device indicates the terminal device to perform multiple repeated transmissions, the terminal device can use Table 1 to determine the redundancy versions corresponding to different transmission times.

For example, assuming that the network device indicates the terminal device to receive PDSCH four times, and the RV identifier carried by the PDSCH scheduled by the network device is 0, the terminal device can determine that the same version of the PDSCH received for the first time is 0, the redundancy version of the PDSCH received for the second time is 2, the redundancy version of the PDSCH received for the third time is 3, and the redundancy version of the PDSCH received for the fourth time is 1.

For uplink signals, multi-slot PUSCH and multi-slot PDSCH have similar transmission mechanisms. The network device can configure an uplink aggregation factor (aggregationFactorUL) for the terminal device. When aggregationFactorUL>1, it means that the same PUSCH TB is repeatedly transmitted in aggregationFactorUL slots. The redundancy version of the TB transmitted for the nth time of repeated transmission may also be determined based on Table 1.

In addition, the slots that can transmit uplink signals and downlink signals are limited by the configuration of the slot structure. The slots or symbols indicated by the current slot structure may include downlink slots or symbols, uplink slots or symbols, and flexible slots or symbols.

The terminal device can only transmit uplink signals in uplink slots or symbols and flexible slots or symbols, but cannot transmit uplink signals in downlink slots or symbols. In addition, when indicating the terminal device to send the PUSCH multiple times, the network device may also indicate the terminal device at which symbol positions in a slot to send the PUSCH. After the terminal device receives the indication of the network device, it can send the PUSCH at the corresponding symbol position. However, if a certain slot includes downlink symbols in the allocated symbols for PUSCH transmission, the terminal device cannot transmit the PUSCH in this slot. The terminal device ignores the transmission of the PUSCH in this slot. If the positions of the allocated symbols for PUSCH transmission in a certain slot are all uplink symbols or flexible symbols, the terminal device can send the PUSCH in this slot.

The terminal device can only receive downlink signals in downlink slots or symbols and flexible slots or symbols, but cannot receive downlink signals in uplink slots or symbols. In addition, when indicating the terminal device to receive the PDSCH multiple times, the network device may also indicate the terminal device at which symbol positions in a slot to receive the PDSCH. After the terminal device receives the indication of the network device, it will receive the PDSCH at the corresponding symbol position. However, if a certain slot includes uplink symbols in the allocated symbols for PDSCH transmission, the terminal device cannot receive PDSCH in this slot. The terminal device ignores the reception of PDSCH for this slot. If the positions of the allocated symbols for PDSCH transmission in a certain slot are all downlink symbols or flexible symbols, the terminal device can receive PDSCH in this slot.

The slot structure is described below.

Taking NR as an example, NR supports a flexible uplink and downlink slot structure. Each slot can be configured as an uplink slot, a downlink slot, and a flexible slot, and the direction of each symbol in each slot can also be configured as an uplink symbol, a downlink symbol, and a flexible symbol. Flexible slots or symbols can be scheduled for either the uplink or downlink direction.

For example, when the terminal device needs to perform uplink transmission, flexible slots or symbols can be scheduled for uplink transmission. When the terminal device needs to perform downlink transmission, flexible slots or symbols can be scheduled for downlink transmission.

The network device can notify the terminal device of the slot structure in the following three manners.

Manner 1: The network device may indicate the uplink and downlink slot structure to the terminal device through a broadcast message. The structure of the uplink and downlink slots indicated by the broadcast message may be at a cell level.

The broadcast message may be used to configure a slot structure within a period, and the length of the period may be pre-configured, for example, the period may be 10 ms.

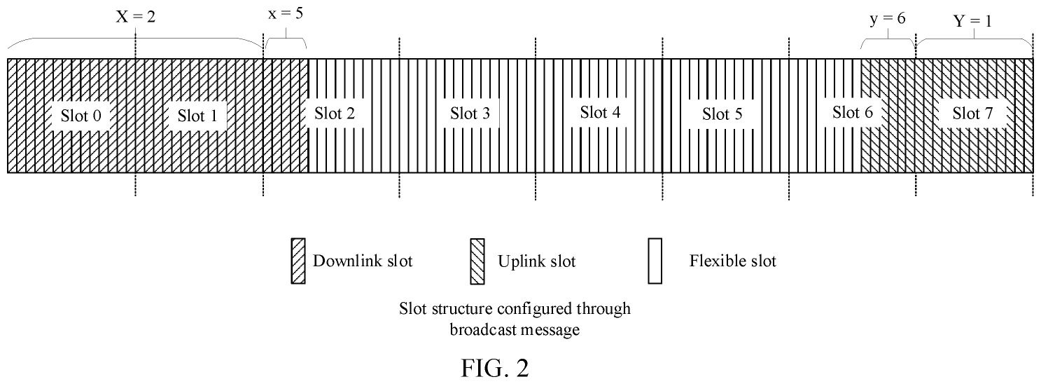

As illustrated in FIG. 2, the broadcast message may indicate uplink slots or symbols, downlink slots or symbols, and flexible slots or symbols through X, x, Y, and y. X indicates that the first X slots are downlink slots, and x indicates that the first x symbols of the (X+1)th slot are downlink symbols. Y indicates that the last Y slots are uplink slots, and y indicates that the last y symbols of the last (Y+1)th slot are uplink symbols. The remaining slots or symbols are flexible slots or symbols.

FIG. 2 illustrates a slot structure of eight slots, where X=2, x=5, Y=1, y=6. In the eight slots, the first two slots are downlink slots, the first five symbols in the third slot are downlink symbols, and the last one slot is an uplink slot. The last six symbols in the penultimate slot are uplink symbols, and the remaining slots or symbols are flexible slots or symbols.

Manner 2: The network device may indicate the uplink and downlink slot structure to the terminal device through radio resource control (RRC) signaling. The uplink and downlink slot structures indicated by the RRC signaling may be at the UE level.

The network device can configure the slot structure of the designated slot in one cycle through RRC dedicated signaling. The period may be the same as that of the slot structure in Manner 1.

This manner can only change the direction of flexible slots or symbols in the slot structure configured in manner 1. This cannot change the direction of the uplink slot or symbol that has been configured by manner 1, nor can it change the direction of the downlink slot or symbol that has been configured by manner 1. That is to say, this method can further perform uplink and downlink configuration on flexible slots or symbols on the basis of manner 1.

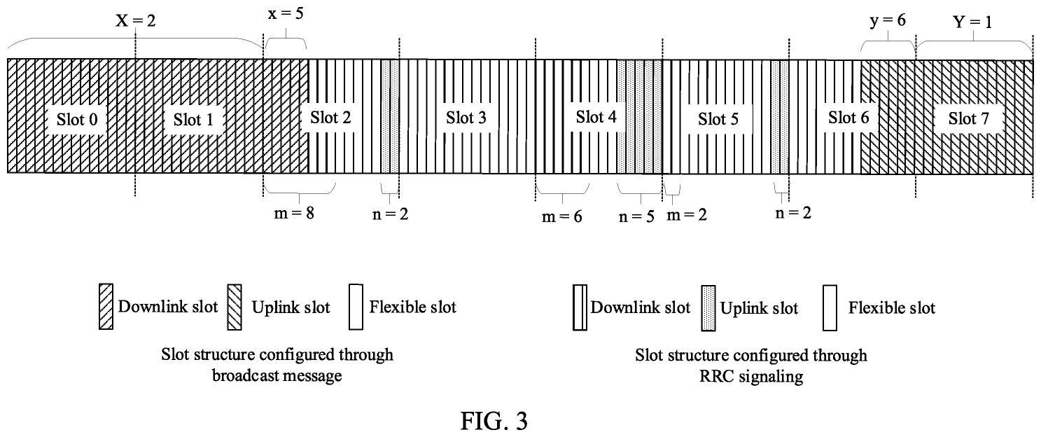

As illustrated in FIG. 3, the RRC signaling can configure uplink symbols and downlink symbols in one slot. The network device can configure the uplink symbols and downlink symbols in a slot through m and n, where m indicates that the first m symbols in a slot are downlink symbols, and n indicates that the last n symbols in a slot are uplink symbols.

For example, the network device may configure the first eight symbols in the third slot as downlink symbols, and the last two symbols in the third slot as uplink symbols. The network device may also configure the first six symbols in the fifth slot as downlink symbols, and the last five symbols in the fifth slot as uplink symbols. The network device may also configure the first two symbols in the sixth slot as downlink symbols, and the last two symbols in the sixth slot as uplink symbols. In addition, other slots or symbols not configured by the RRC signaling are flexible slots or symbols.

Manner 3: The network device indicates the slot structure to the terminal device through a slot format indicator (SFI) carried in a downlink control information (DCI).

The period of the slot structure indicated in this manner may be the same as that of the slot structure in manner 1, or may be different.

This manner can only change the direction of flexible slots or symbols configured in manner 1 and manner 2, and cannot change the direction of configured uplink slots or symbols, and the direction of downlink slots or symbols.

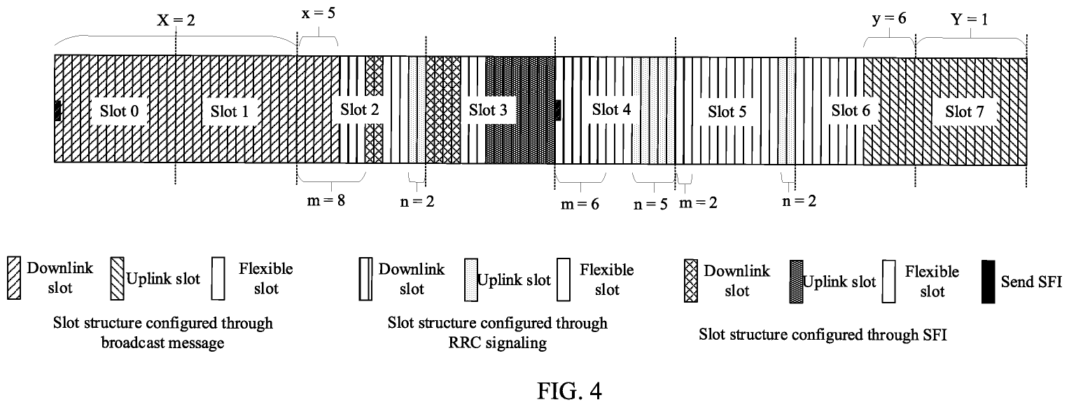

The SFI can be used to indicate the slot structure of K slots, where K≥1. As illustrated in FIG. 4, the configuration period of the SFI may be 4 slots. That is to say, among the eight slots illustrated in FIG. 4, the first four slots are a slot structure configured by one SFI, and the last four slots are a slot structure configured by another SFI.

As illustrated in FIG. 4, in the first SFI cycle, the SFI can be used to configure the ninth and tenth symbols in the third slot as downlink symbols. The first four symbols in the fourth slot are downlink symbols, and the last seven symbols in the fourth slot are uplink symbols. In the second SFI cycle, SFI can be used to configure the eighth and ninth symbols in the first slot as uplink symbols. The third to sixth symbols in the second slot are downlink symbols, and the tenth to twelfth symbols in the second slot are uplink symbols. The first four symbols in the third slot are downlink symbols, and the seventh and eighth symbols in the third slot are uplink symbols.

FIG. 2, FIG. 3, and FIG. 4 illustrate slot structures with a subcarrier spacing of 15 kHz, the embodiment of the present application is not limited to this, and the subcarrier spacing of the embodiment of the present application may also be 30 kHz, 60 kHz, or the like.

Multi-slot PDSCH/PUSCH transmission mechanism supported by NR has the following characteristics:

1) The multi-slot PDSCH/PUSCH is transmitted in multiple slots.

2) The multi-slot PDSCH can be transmitted in downlink slots, or in slots in which all allocated symbols are downlink symbols or flexible symbols, or in flexible slots.

3) The multi-slot PUSCH can be transmitted in uplink slots, or in slots in which all allocated symbols are uplink symbols or flexible symbols, or in flexible slots.

On the one hand, in general, in order to obtain the flexibility of uplink and downlink slot allocation, the NR system configures limited slots as uplink slots or downlink slots through a higher layer signaling (such as broadcast messages or RRC signaling). However, more slots are configured as flexible slots, and the transmission direction of the flexible slots can be determined by the immediate uplink or downlink scheduling requirements. If the immediate uplink traffic volume is large, more flexible slots can be scheduled as uplink slots. Conversely, if the immediate downlink traffic volume is large, more flexible slots can be scheduled as downlink slots.

On the other hand, for IoT devices, if the signal loss to be supplemented by coverage recovery and coverage enhancement is relatively large, it is necessary to perform multiple repeated transmissions on PDSCH and PUSCH. However, if the above repetition mechanism based on NR is used, the flexible slots or symbols in the PDSCH repetition process can be used for PDSCH transmission, and the flexible slots or symbols in the PUSCH repetition process can be used for PUSCH transmission. Then multi-slot PDSCH transmission will result in that the flexible slots in the multi-slot PDSCH transmission process are limited to downlink slots, while multi-slot PUSCH transmission will cause the flexible slots in the multi-slot PUSCH transmission process to be limited to uplink slots.

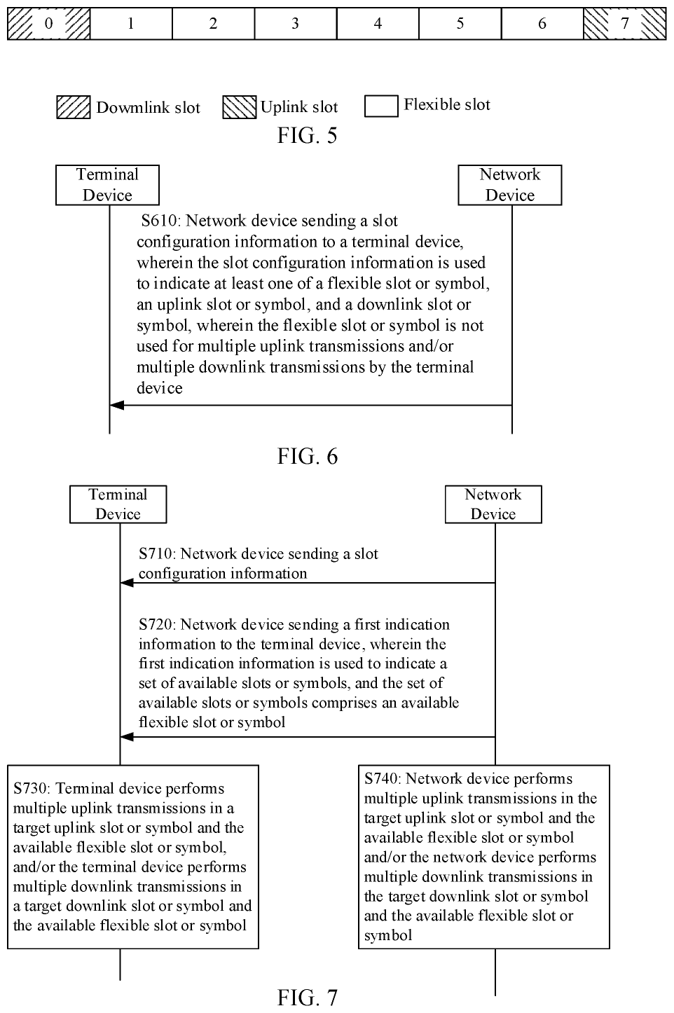

In the slot structure illustrated in FIG. 5, slot 0 is configured as a downlink slot, slot 1 to slot 6 are configured as flexible slots, and slot 7 is configured as an uplink slot. It is assumed that the network device sends DCI in slot 0, and the terminal device is scheduled to perform multi-slot PDSCH transmission in slot 0 to slot 3. Based on the above-mentioned repeated transmission mechanism, slot 1 to slot 3, which are flexible slots, can transmit PDSCH, and slot 1 to slot 3 are limited to downlink slots. If the multi-slot PDSCH transmission requires more times, for example, the network device schedules the terminal device to perform 20 repeated PDSCH receptions, then in the slot structure illustrated in FIG. 5, slot 1 to slot 6 will be limited to downlink slots.

The restriction on the slot direction of multi-slot PDSCH and multi-slot PUSCH may be inconsistent with the requirements of the network device for other terminal services on the slot direction.

For example, the restrictions on the slot direction of IoT devices are inconsistent with the requirements of enhanced mobile broadband (eMBB) devices or ultra-reliable low latency communication (URLLC) devices for slot directions. The restriction of the flexible slot direction by IoT devices will affect the scheduling of services of other terminal devices.

For example, multi-slot PDSCH transmission will cause the flexible slots in the multi-slot PDSCH transmission process to be limited to downlink slots. However, other terminal device may have a large uplink scheduling requirement, and the flexible slot needs to be scheduled as uplink. This will result in the inability of the uplink services of other terminal devices. For another example, multi-slot PUSCH transmission will cause the flexible slots in the multi-slot PUSCH transmission process to be limited to uplink slots. However, other terminal devices may have greater downlink scheduling requirements, and the flexible slots need to be scheduled as uplinks. This will cause downlink services of another terminal device to fail. Therefore, the current transmission mechanism of uplink and downlink signals has the problem of scheduling conflict, which will affect the working efficiency of the system.

The embodiments of the present application provide a wireless communication method, which can enable the transmission of multi-slot PDSCH and multi-slot PUSCH for terminal device to coexist well with scheduling for other terminal device, thereby improving system work efficiency. As illustrated in FIG. 6, the method includes step S610.

S610: A network device sending a slot configuration information to a terminal device, wherein the slot configuration information is used to indicate at least one of a flexible slot or symbol, an uplink slot or symbol, and a downlink slot or symbol.

In other words, the slot configuration information may be used to indicate a slot format, wherein the slot format includes a flexible symbol and at least one of an uplink symbol and a downlink symbol.

The flexible slot or symbol is not used by the terminal device to perform multiple uplink transmissions and/or multiple downlink transmissions, the multiple uplink transmissions are same uplink transmissions, and the multiple downlink transmissions are same downlink transmissions.

The multiple transmissions sending in the embodiment of the present application are scheduled by the network device to the terminal device through a physical downlink control channel (PDCCH).

The multiple transmissions in this embodiment of the present application may include two or more transmissions.

When a terminal device performs multiple uplink transmissions, it only performs uplink transmission in uplink slots or symbols, and does not perform uplink transmission in flexible slots or symbols; and/or when the terminal device performs multiple downlink transmissions, it only performs downlink transmission in downlink slots or symbols, and does not perform downlink transmission in flexible slots or symbols.

The uplink transmission in the embodiment of the present application may include an uplink signal or an uplink channel, and may also include other uplink transmission; the downlink transmission may include a downlink signal or a downlink channel, and may also include other downlink transmission.

The following description will be given as an example of an uplink signal or an uplink channel, a downlink signal or a downlink channel.

Sending the uplink signal or the uplink channel multiple times may mean that the terminal device repeatedly transmits the same uplink signal or the uplink channel. That is to say, the terminal device can transmit the same uplink signal or uplink channel multiple times in multiple slots. Receiving the downlink signal or downlink channel multiple times may mean that the terminal device repeatedly receives the same downlink signal or downlink channel. That is, the terminal device can receive the same downlink signal or downlink channel multiple times in multiple slots.

For the case where the uplink signal or the uplink channel is the PUSCH, the redundancy versions of the PUSCH sent by the terminal device each time may be the same or different. For example, the terminal device may determine the redundancy version of the PUSCH sent each time according to the manner in Table 1.

For the case where the downlink signal or the downlink channel is the PDSCH, the redundancy versions of the PDSCH sent by the network device each time may be the same or different. For example, the network device may determine the redundancy version of the PDSCH sent each time according to the manner in Table 1.

In this embodiment of the present application, when the terminal device sends the uplink signal or the uplink channel, it only sends the uplink signal or the uplink channel in the uplink slot or the uplink symbol configured by the network device. That is to say, even if the slot structure configured by the network device includes flexible slots or symbols, the terminal device will not perform uplink transmission in the flexible slots or symbols. When the terminal device receives the downlink signal or the downlink channel, it only receives the downlink signal or the downlink channel in the downlink slot or symbol configured by the network device. That is to say, even if the slot structure configured by the network device includes flexible slots or symbols, the terminal device will not perform downlink transmission in the flexible slots or symbols.

The transmission of the multi-slot PDSCH of the terminal device is restricted to be performed only in downlink slots or symbols. Transmission of multi-slot PUSCH is restricted to only uplink slots or symbols. This allows the transmission of multi-slot PDSCH and multi-slot PUSCH not to occupy flexible slots or symbols. Thus, it is avoided that multi-slot PDSCH transmission restricts flexible slots or symbols to downlink slots or symbols. Multi-slot PUSCH transmission restricts flexible slots or symbols to uplink slots or symbols, and affects the service scheduling of another terminal device.

For the uplink transmission, the network device may also indicate the symbol position for the terminal device to perform the uplink transmission.

For example, the network device may indicate the terminal device on which symbols in a slot to transmit the uplink signal or uplink channel. The terminal device can then transmit the uplink signal or the uplink channel at the positions where the symbol positions are all uplink symbols.

For example, the network device may send first indication information to the terminal device, where the first indication information is used to indicate the terminal device to send an uplink signal or a symbol bit position of an uplink channel. When a terminal device sends an uplink signal or an uplink channel, the following determination can be made. If the symbol position indicated by the first indication information in the first slot includes downlink symbols and/or flexible symbols, or the first slot is a downlink slot and/or a flexible slot, the terminal device does not send the uplink signal or the uplink channel in the first slot. If the symbol positions indicated by the first indication information in the second slot are all uplink symbols, or the second slot is an uplink slot, the terminal device can send an uplink signal or an uplink channel in the second slot.

When the network device receives the uplink signal or the uplink channel, it can also make the following determination. If the symbol position indicated by the first indication information in the first slot includes downlink symbols and/or flexible symbols, or the first slot is a downlink slot and/or a flexible slot, the network device may not receive the uplink signal or the uplink channel in the first slot. If the symbol positions indicated by the first indication information in the second slot are all uplink symbols, or the second slot is an uplink slot, the network device can receive the uplink signal or the uplink channel in the second slot.

The network device may indicate the terminal device on which symbols in a slot to transmit the uplink signal or uplink channel.

For example, the network device indicates the terminal device to send an uplink signal or an uplink channel on the first five symbols in a slot, and the symbol positions in the first slot corresponding to the first indication information indicate the first five symbol positions in the first slot.

The network device may also indicate the number of times of sending the uplink transmission. For example, the network device may indicate the terminal device to send the uplink signal or the number of times the uplink channel is sent M times, where M is an integer greater than 1.

The number of times the network device indicates the terminal device to send the uplink signal or the uplink channel indicates the number of times the network device expects the terminal device to send the uplink signal or the uplink channel. The actual sending times of the terminal device may be less than or equal to the sending times expected by the network device. When the network device receives the uplink signal or the uplink channel, the actual number of times of reception by the network device is less than or equal to the number of times expected by the network device.

The M times may represent the actual transmission times of the uplink signal or the uplink channel. For example, the terminal device can transmit the uplink signal or the uplink channel in the uplink slot or symbol until the actual number of times of sending the uplink signal or the uplink channel reaches M times, and then the terminal device can end the transmission of the uplink signal or the uplink channel.

For example, it is assumed that slots 1, 2, 5, 6, and 7 are uplink slots, and slots 3 and 4 are flexible slots. The network device schedules the terminal device to transmit the uplink signal or uplink channel 5 times in slot 0, and then the terminal device can send the uplink signal or uplink channel on slots 1, 2, 5, 6, and 7. Because the terminal device cannot send the uplink signal or the uplink channel on the slots 3 and 4. Therefore, Therefore, after the terminal device has sent the uplink signal or the uplink channel on the slot 7, this can satisfy the actual transmission of five times, and then the transmission of the uplink signal or the uplink channel can be ended.

The M times may also indicate that the number of consecutive slots that have passed since the first slot indicated by the network device for sending the uplink signal or the uplink channel is M.

For example, the terminal device can transmit the uplink signal or the uplink channel in the uplink slot or symbol until the number of slots that have passed from the first slot reaches M, and the terminal device can end the uplink signal or the transmission of the uplink channel. In this case, the actual number of transmissions of the uplink signal or the uplink channel is less than or equal to M times.

For the case where the uplink signal or the uplink channel is PUSCH, the first slot is the first slot of the uplink grant indication sent by the network device.

For the case where the uplink signal or uplink channel is a sounding reference signal (SRS), a physical random access channel (PRACH), and a PUCCH, the first slot is the first slot in the set of slots configured by the network device for transmitting the uplink signal or the uplink channel.

For example, it is assumed that slots 1, 2, 5, 6, and 7 are uplink slots, slots 3 and 4 are flexible slots, and the network device schedules the terminal device to transmit the uplink signal or uplink channel five times in slot 0, then the terminal device can send the uplink signal or the uplink channel on slots 1, 2, and 5. Although the terminal device cannot transmit the uplink signal or the uplink channel on slots 3 and 4, the two slots 3 and 4 are also counted in the five transmissions. Therefore, after the terminal device finishes sending the uplink signal or the uplink channel on slot 5, it ends the transmission of the uplink signal or the uplink channel.

For example, the first indication information may be an uplink scheduling grant, that is, the first indication information may be carried in the PDCCH.

The network device may use an indication information to simultaneously indicate the symbol position for sending the uplink signal or the uplink channel and the number of times for sending the uplink signal or the uplink channel. Alternatively, the network device may also use two indication information to respectively indicate the symbol position for sending the uplink signal or the uplink channel and the number of times for sending the uplink signal or the uplink channel. This embodiment of the present application does not specifically limit this.

Taking FIG. 4 as an example, the slot structure jointly determined by the terminal device according to the broadcast message, RRC signaling, and SFI DCI is illustrated in FIG. 4.

The network device sends the first indication information to the terminal device at the position of slot 2. The first indication information indicates the terminal device to send an uplink signal or an uplink channel on the last five symbols in a slot. The first indication information also indicates that the terminal device needs to send the uplink signal or the uplink channel five times. Since the positions of the last five symbols in the slot 2 include flexible symbols and downlink symbols, the terminal device cannot send the uplink signal or the uplink channel on the slot 2. The terminal device can send uplink signals or uplink channels in the last five symbol positions of slot 3 to slot 7.

For downlink transmission, the network device may also indicate the symbol position of the terminal device for downlink transmission.

For example, the network device may indicate the terminal device on which symbols in a slot to receive the downlink signal or downlink channel. The terminal device can then receive downlink signals or downlink channels at the positions where the symbol positions are all downlink symbols.

For example, the network device may send the second indication information to the terminal device. The second indication information is used to indicate the terminal device to receive the downlink signal or the symbol bit position of the downlink channel. When a terminal device receives a downlink signal or a downlink channel, the following determination can be made. If the symbol position corresponding to the second indication information in the third slot includes uplink symbols and/or flexible symbols, the terminal device does not receive downlink signals or downlink channels in the third slot. If the symbol positions indicated by the second indication information in the fourth slot are all downlink symbols, the terminal device may receive downlink signals or downlink channels in the fourth slot.

The network device may also make the following determinations when sending downlink signals or downlink channels. If the symbol positions indicated by the second indication information in the third slot include uplink symbols and/or flexible symbols, or the third slot is an uplink slot and/or a flexible slot, then the network device does not send downlink signals or downlink channels in the third slot. If the symbol positions indicated by the second indication information in the fourth slot are all downlink symbols, or the fourth slot is a downlink slot, then the network device can send the downlink signal or downlink channel in the fourth slot.

In some cases, the network device also indicates the terminal device on which symbols in a slot the downlink signal or downlink channel should be received.

For example, the network device indicates the terminal device to receive the downlink signal or downlink channel on the first five symbols in a slot, then, the symbol positions in the third slot corresponding to those indicated by the second indication information represent the first five symbol positions in the third slot.

The network device may also indicate the number of times the downlink signal or downlink channel is received.

For example, the network device may indicate the terminal device to receive N times of downlink signals or downlink channels, where N is an integer greater than 1.

The number of times the network device indicates the terminal device to receive the downlink signal or the downlink channel indicates the number of times the network device expects the terminal device to receive the downlink signal or the downlink channel. The actual number of receptions by the terminal device may be less than or equal to the number of receptions expected by the network device. When the network device sends downlink signals or downlink channels, the actual number of times of sending by the network device is less than or equal to the number of times expected by the network device.

The N times may represent the number of downlink signals or downlink channels actually received by the terminal device.

For example, the terminal device may receive downlink signals or downlink channels multiple times in downlink slots or symbols until the actual number of times of reception of downlink signals or downlink channels reaches N times. The terminal device can then end the reception of the downlink signal or downlink channel. Similarly, the network device may also send downlink signals or downlink channels multiple times on downlink slots or symbols until the actual number of times of sending downlink signals or downlink channels reaches N times. The network device may end the transmission of the downlink signal or downlink channel.

For example, suppose that slots 1, 2, 5, 6, and 7 are downlink slots, and slots 3 and 4 are flexible slots, the network device schedules the terminal device to transmit downlink signals or downlink channels five times in slot 1. The network device can send downlink signals or downlink channels on slots 1, 2, 5, 6, and 7, and the terminal device can receive downlink signals or downlink channels on slots 1, 2, 5, 6, and 7. The terminal device cannot receive downlink signals or downlink channels on slots 3 and 4. Therefore, after the terminal device has received the downlink signal or downlink channel on slot 7, this can satisfy the actual transmission of five times, and the terminal device can end the reception of the downlink signal or the downlink channel. The network device can only end the sending of the downlink signal or the downlink channel after the downlink slot or symbol is sent on the slot 7.

The N times may also mean that the terminal device can receive the downlink signal or downlink channel multiple times in consecutive N slots starting from the first slot indicated by the network device for receiving the downlink signal or downlink channel.

For example, the terminal device may receive downlink signals or downlink channels on downlink slots or symbols until the number of slots elapsed from the first slot reaches N, and the terminal device may end the downlink signal or downlink channel reception. Similarly, the network device may send downlink signals or symbols multiple times on downlink slots or symbols until the number of slots that have passed since the first slot indicated to the terminal device for receiving the downlink signal or downlink channel reaches N.

In this case, the number of downlink signals or downlink channels actually received by the terminal device is less than or equal to N times, and the number of times the downlink signals or downlink channels actually sent by the network device is less than or equal to N times.

For example, it is assumed that slots 1, 2, 5, 6, and 7 are downlink slots, and slots 3 and 4 are flexible slots. The network device schedules the terminal device to transmit the downlink signal or downlink channel five times in slot 1. The network device can send downlink signals or downlink channels on slots 1, 2, and 5, and the terminal device can receive downlink signals or downlink channels on slots 1, 2, and 5. Although the terminal device cannot receive downlink signals or downlink channels on slots 3 and 4, the two slots 3 and 4 are also counted in the five transmissions. Therefore, after receiving the downlink signal or downlink channel on slot 5, the terminal device ends the reception of the downlink signal or downlink channel. Similarly, after the network device finishes sending the downlink signal or downlink channel on slot 5, the network device ends the transmission of the downlink signal or downlink channel.

For example, the second indication information may be a downlink scheduling grant, that is, the second indication information may be carried in a physical downlink control channel (PDCCH).

The network device may use an indication information to simultaneously indicate the symbol position of the received downlink signal or the downlink channel and the number of times of receiving the downlink signal or the downlink channel. Alternatively, the network device may also use two indication information to respectively indicate the symbol position of the received downlink signal or the downlink channel and the number of times of receiving the downlink signal or the downlink channel. This embodiment of the present application does not specifically limit this.

Taking FIG. 4 as an example, the slot structure jointly determined by the terminal device according to the broadcast message, RRC signaling, and SFI DCI is illustrated in FIG. 4. The network device sends the second indication information to the terminal device at the position of slot 0. The second indication information indicates the terminal device to receive downlink signals or downlink channels on the first five symbols in a slot. The first indication information also indicates that the terminal device needs to receive the downlink signal or downlink channel five times. Since the positions of the first five symbols in slot 3 include flexible symbols, the terminal device cannot receive downlink signals or downlink channels in slot 3. The terminal device can receive downlink signals or downlink channels at the first five symbol positions of slots 0, 1, 2, 4, and 5.

The embodiments of the present application do not specifically limit the uplink signal or the uplink channel and the downlink signal or the downlink channel.

For example, the uplink channel may include at least one of the following: PUSCH, physical uplink control channel PUCCH), and PRACH, and/or the uplink signal may be SRS, and/or the downlink channel may include at least one of the following: PDSCH and PDCCH.

The slot configuration information may be sent in any one or more of the three manners described above.

For example, the slot configuration information may include the slot configuration information sent by the network device to the terminal device through a higher layer signaling. The higher layer signaling may include, for example, system broadcast messages and/or RRC signaling. For another example, the slot configuration information may include slot configuration information sent by the network device through the SFI DCI.

That is, the network device can configure the slot structure to the terminal device by at least one of broadcast messages, RRC signaling, and SFI DCI.

If the network device only sends the slot configuration information to the terminal device through a broadcast message, the terminal device can determine the uplink slot or symbol, downlink slot or symbol, flexible slot or symbol according to the slot configuration information, as illustrated in FIG. 2. If the network device sends the first slot configuration information to the terminal device through a broadcast message and sends the second slot configuration information to the terminal device through RRC signaling, the terminal device can jointly determine the uplink slot or symbol, the downlink slot or symbol, and the flexible slot or symbol according to the first slot configuration information and the second slot configuration information, as illustrated in FIG. 3. If the network device sends the first slot configuration information to the terminal device through a broadcast message, sends the second slot configuration information to the terminal device through RRC signaling, and also sends the third slot configuration information to the terminal device through SFI DCI, the terminal device can jointly determine the uplink slot or symbol, downlink slot or symbol, and flexible slot or symbol according to the first slot configuration information, the second slot configuration information, and the third slot configuration information, as illustrated in FIG. 4.

In this embodiment of the present application, the slot structure configured by the RRC signaling may be based on the slot structure configured by the broadcast message. That is, the RRC signaling further configures the flexible slots or symbols configured in the broadcast message, without changing the direction of the uplink slots or symbols, and the direction of the downlink slots or symbols already configured in the broadcast message. Of course, the slot structure configured by the RRC signaling may not be based on the slot structure configured by the broadcast message. That is, when the terminal device determines the slot structure, it only determines the uplink slot or symbol, the downlink slot or symbol, and the flexible slot or symbol according to the slot configuration information in the RRC signaling.

Similarly, the slot structure configured by the SFI DCI may be a slot structure configured based on broadcast messages and RRC signaling. That is, the SFI DCI further configures the flexible slots or symbols configured by the broadcast message and the RRC signaling, without changing the direction of the uplink slots or symbols, and the direction of the downstream slots or symbols already configured by the broadcast message and the RRC signaling. Of course, the SFI DCI may not be based on the slot structure configured by broadcast messages and RRC signaling. That is to say, when determining the slot structure, the terminal device can only determine the uplink slot or symbol, the downlink slot or symbol, and the flexible slot or symbol according to the slot configuration information in the SFI DCI.

The terminal device in this embodiment of the present application may include an Internet of Things device or a non-Internet of Things device.

The slot configuration information sent by the network device to the IoT device and the non-IoT device may be the same or partially the same. Alternatively, the slot configuration information sent by the network device to the IoT device and the non-IoT device may also be different.

In the case where the network device sends the slot configuration information to the terminal device through at least one of broadcast messages, RRC signaling, and SFI DCI, the slot configuration information sent by the network device to the IoT device is the same as the slot configuration information sent to the non-IoT device. This can refer to a network device sending the same slot configuration information to IoT devices and non-IoT devices via broadcast messages, the network device sends the same slot configuration information to the IoT device and the non-IoT device through RRC signaling, and/or the network device sends the same slot configuration information to the IoT device and the non-IoT device through the SFI DCI.

If the slot structure configured by the network device to the IoT device and the non-IoT device is the same, there will be no conflict in the uplink and downlink scheduling of the network device to the IoT device and the non-IoT device.

In the case that the network device sends the slot configuration information to the terminal device through a broadcast message, the slot configuration information sent by the network device to the IoT device is different from the slot configuration information sent by the network device to the non-IoT device. This can mean that the network device sends different slot configuration information to the IoT device and the non-IoT device through the same broadcast message, or the network device sends different slot configuration information to the IoT device and the non-IoT device through different broadcast message.

In the case that the network device sends slot configuration information to the terminal device through RRC signaling. The slot configuration information sent by the network device to the IoT device is different from the slot configuration information sent by the network device to the non-IoT device. This can mean that the network device sends different slot configuration information to the IoT device and the non-IoT device through the same RRC signaling, or the network device sends different slot configuration information to the IoT device and the non-IoT device through different RRC signalings.

In the case that the network device sends slot configuration information to the terminal device through the SFI DCI. The slot configuration information sent by the network device to the IoT device is different from the slot configuration information sent by the network device to the non-IoT device. This can refer to that the network device sends different slot configuration information to the IoT device and the non-IoT device through the same SFI DCI, or the network device sends different slot configuration information to the IoT device and the non-IoT device through different SFI DCIs.

The slot configuration information sent by the network device to the IoT device is partially the same as the slot configuration information sent by the network device to the non-IoT device. This can refer to that the network device sends the same slot configuration information to the IoT device and the non-IoT device through the broadcast message, or the network device sends different slot configuration information to the IoT device and the non-IoT device through SFI DCI.

Using SFI DCI to send different slot configuration information to the IoT device and the non-IoT device may refer to using different SFI DCIs to send different slot configuration information to the IoT device and the non-IoT device. That is to say, the network device uses the dedicated SFI DCI to send the slot configuration information to the IoT device. In details, the network device may use the first SFI DCI to send the slot configuration information to the IoT device and use the second SFI DCI to send the slot configuration information to the non-IoT device. The first SFI DCI is different from the second SFI DCI. The IoT device only receives the slot configuration information sent through the first SFI DCI but does not receive the slot configuration information sent through the second SFI DCI.

Different SFI DCIs may refer to different PDCCHs carrying SFI DCIs. Assuming that the network device carries the first SFI DCI through the first PDCCH and the second SFI DCI through the second PDCCH, the first PDCCH and the second PDCCH may be different in at least one of the followings: a transmission period, a transmission time offset within a period, time domain resources occupied by the PDCCHs, frequency domain resources occupied by the PDCCHs, or a cyclic redundancy check (CRC) scrambled with a radio network temporary identifier (RNTI). In this way, the IoT device can receive only the SFI DCI for the IoT device according to the difference of the above-mentioned PDCCH.

If the slot structure configured by the network device to the IoT device and the non-IoT device is different or partially the same. For example, for a certain slot, the network device configures the downlink slot for the IoT device, while the flexible slot is configured for the non-IoT device. In this case, if the network device schedules the IoT device to perform downlink transmission in this slot, the slot is a downlink slot, and the non-Internet of Things device cannot perform uplink transmission in this slot. If the IoT device has no downlink services to transmit within the slot, the network device may schedule the slot as an uplink slot or a downlink slot for the non-IoT device. This method can make full use of system resources and avoid waste of time domain resources.

SFI DCI can be sent periodically. Compared with broadcast message and RRC signaling, the transmission period of SFI DCI is shorter and the configuration is more flexible. Therefore, the way of indicating the slot structure to the terminal device through the SFI DCI is also more flexible. This enables network device to adjust the configuration of uplink and downlink slots more flexibly according to current transmission requirements.

For example, when the transmission demand of the non-IoT device is less, more sets of uplink slots or symbols, and more sets of downlink slots or symbols can be indicated to the IoT device. When there are many transmission demands of the non-Internet of Things device, less sets of uplink slots or symbols, and sets of downlink slots or symbols are indicated to the Internet of Things device, thereby ensuring the flexibility of network scheduling.

This embodiment of the present application may also specify a time range to which the slot structure indicated by the SFI DCI is applied.

For example, the slot structure indicated by the SFI DCI may be applied in the time range between the transmission time of the SFI DCI and the transmission time of the next SFI DCI. If the network device sends the SFI DCI to the terminal device at a certain moment, the terminal device can determine the slot structure according to the SFI DCI before receiving the SFI DCI next time.

The pattern of the slot structure indicated by the SFI DCI may be repeated periodically. The transmission period of the SFI DCI may be greater than or equal to the repetition period of the slot format indicated by the SFI DCI.

For example, the transmission period of the SFI DCI is 20 ms, and the repetition period of the format of the slot structure indicated by the SFI DCI is 4 ms. That is to say, within the transmission time interval of two SFI DCIs of 20 ms, the slot structure can be repeated every 4 ms.

The IoT device in the embodiments of the present application may be IoT device, MTC device, and/or eMTC device, and non-IoT device may be eMBB device and/or URLLC device.

FIG. 7 is another wireless communication method according to an embodiment of the present application, and the method includes steps S710 to S740. For the corresponding technical features in the method illustrated in FIG. 7, reference may be made to the description of FIG. 6. In order to avoid repetition, the description will be simplified below.

S710: A network device sending a slot configuration information to a terminal device, wherein the slot configuration information is used to indicate at least one of a flexible slot or symbol, an uplink slot or symbol, and a downlink slot or symbol.

In other words, the slot configuration information can be used to indicate a slot format, and the slot format includes an uplink symbol, a downlink symbol, and a flexible symbol.

The slot configuration information may be sent by the network device to the terminal device through any one or more of the three manners described above. For details, please refer to the description in FIG. 6.

S720: The network device sending a first indication information to the terminal device, wherein the first indication information is used to indicate a set of available slots or symbols, and the set of available slots or symbols comprises an available flexible slot or symbol. That is, the first indication information can be used to indicate which flexible slots or symbols in the slot format are available.

S730: For the terminal device, the terminal device may perform multiple uplink transmissions in a target uplink slot or symbol and the available flexible slot or symbol, and/or the terminal device may perform multiple downlink transmissions in a target downlink slot or symbol and the available flexible slot or symbol.

The target uplink slot or symbol is part or all of the uplink slot or symbol indicated by the slot configuration information, the target downlink slot or symbol is part or all of the downlink slot or symbol indicated by the slot configuration information, wherein the multiple uplink transmissions are same uplink transmissions, and the multiple downlink transmissions are same downlink transmissions.

Optionally, the target uplink slot or symbol and the target downlink slot or symbol may be indicated by the network device, or may be pre-configured in the terminal device, or may be pre-defined in a protocol.

The multiple transmissions in this embodiment of the present application are scheduled by the network device to the terminal device through one PDCCH.

In the embodiment of the present application, multiple sending includes two or more sending, and multiple receiving includes two or more receiving.

S740: For the network device, the network device may perform multiple uplink transmissions in the target uplink slot or symbol and the available flexible slot or symbol and/or the network device may perform multiple downlink transmissions in the target downlink slot or symbol and the available flexible slot or symbol.

In the embodiment of the present application, after notifying the terminal device of the slot format through the slot configuration information, the network device may further indicate to the terminal device which flexible slots or symbols in the slot format are available. In this way, the terminal device can perform uplink transmission or downlink transmission in the available flexible slots or symbols.

For the technical solutions provided by the embodiments of the present application, for terminal device, not all flexible slots or symbols can be used for uplink transmission or downlink transmission. Instead, the terminal device can only perform uplink transmission or downlink transmission in the available flexible slots configured by the network device. This can prevent some terminal devices from occupying all the flexible slots and affecting the data transmission of other terminal devices.

The uplink transmission in this embodiment of the present application may include an uplink signal or an uplink channel and may also include other uplink transmissions. Downlink transmission may include downlink signals or downlink channels and may also include other downlink transmissions.

The following description will be given as an example of an uplink signal or an uplink channel, a downlink signal, or a downlink channel.

There are two ways for the network device to indicate the set of available slots or symbols, which will be described in detail below.

The first way: when indicating a set of available slots or symbols, the network device may only indicate which flexible slots or symbols are available. In this case, the target uplink slots or symbols are all uplink slots or symbols, and the target downlink slots or symbols are all downlink slots or symbols. The terminal device can perform uplink transmission in all uplink slots or symbols indicated by the slot configuration information and in available flexible slots or symbols. The terminal device can perform downlink transmission in all downlink slots or symbols indicated by the slot configuration information, and available flexible slots or symbols.

It can be understood that all uplink slots or symbols in the embodiments of the present application refer to all uplink slots or symbols indicated by the slot configuration information. All downlink slots or symbols refer to all downlink slots or symbols indicated by the slot configuration information. The available flexible slots or symbols are some or all of the flexible slots or symbols indicated by the slot configuration information. The available uplink slots or symbols are some or all of the uplink slots or symbols in the uplink slots or symbols indicated by the slot configuration information. The available downlink slots or symbols are some or all of the downlink slots or symbols in the downlink slots or symbols indicated by the slot configuration information.

Taking FIG. 5 as an example, the network device can respectively indicate whether the six flexible slots are available through six bits. Assuming that the network device indicates that flexible slot 1 and flexible slot 2 are available, flexible slot 1 and flexible slot 2 can be used for uplink and downlink transmission. Therefore, if the terminal device needs to perform downlink transmission, it can receive downlink signals or downlink channels on flexible slot 2 and flexible slot 3. However, the terminal device cannot receive downlink signals or channels on flexible slots 4 to 7. If the terminal device needs to perform uplink transmission, it can send the uplink signal or the uplink channel on the flexible slot 2 and the flexible slot 3. However, the terminal device cannot send the uplink signal or the uplink channel on the flexible slot 4 to the slot 7.

The second way: when indicating a set of available slots or symbols, the network device may indicate which slots or symbols are available in all the slots or symbols. All slots or symbols represent all slots or symbols indicated by the slot configuration information. That is to say, in addition to indicating available flexible slots or symbols, the network device may also indicate available uplink slots or symbols, and/or available downlink slots or symbols. In this case, the target uplink slot or symbol is an available uplink slot or symbol, and the target downlink slot or symbol is an available downlink slot or symbol.

For example, the network device may indicate available uplink slots or symbols, available downlink slots or symbols, and available flexible slots or symbols. In this case, the terminal device may transmit uplink signals in available uplink slots or symbols and available flexible slots or symbols. A terminal device may receive downlink signals in available downlink slots or symbols and in available flexible slots or symbols. The target uplink slot or symbol in step S730 is the available uplink slot or symbol, and the target downlink slot or symbol is the available downlink slot or symbol.

Assuming that one slot format corresponds to eight slots, the network device can respectively indicate whether the eight slots are available through eight bits.

For example, if the value of the bit corresponding to a certain slot is 1, it means that the slot is available. If the value of the bit corresponding to a certain slot is 0, it means that the slot is unavailable.

The network device may also indicate which symbols are available in a slot, and the specific indication manner is similar to that of indicating available slots.

For example, the network device may use fourteen bits to respectively indicate whether fourteen symbols in a slot are available. This indication manner may be applicable to the above-mentioned available flexible slots, or may be applicable to all flexible slots, or may be applicable to slots in which a part of the symbols are uplink symbols, downlink symbols or flexible symbols. That is to say, the set of available symbols in a slot indicated by the network device may be applicable to all slots, or may only be applicable to flexible slots, or may also be applicable to available flexible slots, or may also be applicable to flexible slots. It applies to all slots in the set of available slots, or it can also apply to slots including at least two kinds of symbols in one slot. The specific applicable slots may be configured by the network device, pre-defined in the protocol, or pre-configured in the terminal device.

Take for example that the set of available symbols is suitable for the available flexible slots. For example, the network device first indicates the available flexible slots for the terminal device, and then the network device may further indicate the available flexible symbols. Still taking FIG. 5 as an example, the network device uses six bits to indicate that flexible slot 1 and flexible slot 2 are available and uses fourteen bits to indicate that the first seven symbols in a slot are available. Then the terminal device can determine that the first seven symbols in the flexible slot 1 and the flexible slot 2 are available, and other flexible slots or symbols are unavailable.

When performing uplink scheduling on the terminal device, the network device may also send second indication information to the terminal device. The second indication information may be used to instruct the terminal device to send the symbol position of the uplink signal or the uplink channel. Then the terminal device may send the uplink signal or the uplink channel at the symbol position indicated by the second indication information.

For example, the network device can instruct the terminal device to send the uplink signal or the uplink channel on the first five symbols in a slot, then the terminal device can only send the uplink signal or the uplink channel on the first five symbols in a slot.

For the terminal device, if the symbol positions indicated by the second indication information in the first slot include symbols that do not belong to the target uplink symbols and available flexible symbols, that is, the symbol positions indicated by the second indication information in the first slot include at least one of the following: downlink symbols, unavailable flexible symbols, and unavailable uplink symbols, then the terminal device may not send the uplink signal or the uplink channel in the first slot. If the symbol positions indicated by the corresponding second indication information in the second slot are both target uplink symbols and available flexible symbols, the terminal device can send the uplink signal or the uplink channel in the second slot.

For the network device, if the symbol positions indicated by the corresponding second indication information in the first slot include symbols that do not belong to the target uplink symbols and available flexible symbols, that is, if the symbol position indicated by the first slot corresponding to the second indication information includes at least one of the following: downlink symbols, unavailable flexible symbols, unavailable uplink symbols, then the network device may not receive the uplink signal or the uplink channel in the first slot. If the symbol positions indicated by the corresponding second indication information in the second slot are both target uplink symbols and available flexible symbols, the network device may receive the uplink signal or the uplink channel in the second slot.

The second indication information is further used to instruct the terminal device to send the uplink signal or the uplink channel for M times. The M times may refer to the actual number of times that the terminal device sends the uplink signal or the uplink channel is M times. Alternatively, it may refer to the number of consecutive slots that the terminal device passes through from the first slot indicated by the network device for transmitting the uplink signal or the uplink channel to reach M. For details, please refer to the description of FIG. 6.

The second indication information may be an uplink scheduling grant, and the network device may send the second indication information to the terminal device while scheduling the uplink grant to the terminal device.

It can be understood that, in addition to using the second indication information to simultaneously indicate the terminal device to send the symbol position of the uplink signal or uplink channel and the number of times of transmission, the network device may also use different indication information to indicate the terminal device to send the symbol position of the uplink signal or uplink channel, and the number of times of sending, which are not specifically limited in this embodiment of the present application.

When performing downlink scheduling on the terminal device, the network device may also send third indication information to the terminal device. The third indication information is used to indicate the terminal device to receive the symbol position of the downlink signal or the downlink channel, and then the terminal device can receive the downlink signal or the downlink channel at the symbol position indicated by the third indication information.

For example, the network device can indicate the terminal device to receive downlink signals or downlink channels on the first five symbols in a slot, then the terminal device can only receive downlink signals or downlink channels on the first five symbols in a slot.

For the terminal device, if the symbol positions indicated by the third indication information in the third slot include symbols that do not belong to the target downlink symbols and the available flexible symbols, that is, the symbol positions indicated by the third indication information in the third slot include at least one of the following: uplink symbols, unavailable flexible symbols, and unavailable downlink symbols, then the terminal device may not receive the downlink signal or downlink channel in the third slot. If the symbol positions indicated by the third indication information in the fourth slot are both target downlink symbols and available flexible symbols, the terminal device can receive downlink signals or downlink channels in the fourth slot.

For the network device, if the symbol positions indicated by the third indication information in the third slot include symbols that do not belong to the target downlink symbols and the available flexible symbols, that is, if the symbol positions indicated in the third slot corresponding to the third indication information include at least one of the following: uplink symbols, unavailable flexible symbols, and unavailable downlink symbols, then the network device may not send downlink signals or downlink channels in the third slot. If the symbol positions indicated by the third indication information in the fourth slot are both target downlink symbols and available flexible symbols, the network device may send downlink signals or downlink channels in the fourth slot.

The third indication information is further used to indicate that the number of times the terminal device receives the downlink signal or downlink channel is N times. The N times may refer to the actual number of times the terminal device receives downlink signals or downlink channels is N times. Alternatively, the N times may indicate that the number of consecutive slots passed by the terminal device from the first slot indicated by the network device for receiving the downlink signal or downlink channel reaches N. For details, please refer to the description of FIG. 6.

The third indication information may be, for example, a downlink scheduling grant, and the network device may send the third indication information to the terminal device while scheduling the downlink grant to the terminal device.

It can be understood that, in addition to using the third indication information to simultaneously instruct the terminal device to receive the symbol position of the downlink signal or downlink channel and the number of times of reception, the network device may also use different indication information to instruct the terminal device to receive the symbol position of the downlink signal or downlink channel, and the number of times of reception, which are not specifically limited in this embodiment of the present application.

The first indication information in the method illustrated in FIG. 7 may be sent by the network device to the terminal device through a higher layer signaling and/or DCI. The higher layer signaling may include a broadcast message and/or an RRC signaling.

When the network device sends the first indication information through the DCI, an indication field may be set in the DCI to indicate a set of available slots or symbols.

This embodiment of the present application does not specifically limit the manner in which the first indication information indicates the set of available slots or symbols.

As an example, the first indication information may indicate a set of available slots or symbols to the terminal device by means of a bitmap. Referring to the above description, the network device may indicate whether the slot is available by means of a bit indicating a slot. In addition, the network device can also indicate whether the symbol of a slot is available by means of a bitmap.

To save bits, the overhead of compressing the bitmap can be considered. A network device may use one bit to indicate whether multiple slots or symbols are available.

For example, one bit may be used to indicate whether two slots or symbols are available. If one slot configuration period includes ten slots, only five bits can be used to indicate whether the ten slots are available.

As yet another example, the first indication information may be used to indicate an index of a set of available slots or symbols. The terminal device may determine the set of available slots or symbols according to the index of the set of available slots or symbols.

For example, the network device may send configuration information of at least one set of slots or symbols and an index of the at least one set of slots or symbols to the terminal device. Specifically, the network device may pre-configure and number several possible sets of available slots or symbols to the terminal device through RRC signaling. Afterwards, the network device may indicate the index of the available slot or symbol to the terminal device through the DCI. After the terminal device receives the index of the set of available slots or symbols sent by the network device, the terminal device can determine the set of available slots or symbols according to the index sent by the network device and the above configuration information.

As yet another example, the network device may indicate whether flexible slots or symbols are available. For example, the network device may send the fourth indication information to the terminal device. The fourth indication information may be used to indicate whether flexible slots or symbols are available. The flexible timeslots or symbols here may refer to all flexible timeslots or symbols indicated by the timeslot configuration information.

For example, the fourth indication information may use one bit to indicate whether flexible slots or symbols are available. If the value of this bit is 1, it indicates that flexible slots or symbols are available. If the value of this bit is 0, it means that the flexible slot or symbol is not available.

The fourth indication information may be carried on the DCI.

In addition, the network device may indicate whether some flexible slots or symbols are available through the fifth indication information. The part of flexible slots or symbols is a subset of all flexible slots or symbols.

The part of the flexible slots or symbols may be pre-configured by the network device to the terminal device through a higher layer signaling.

For example, the fifth indication information may use one bit to indicate whether the part of the flexible slot or symbol is available. If the value of this bit is 1, it indicates that this part of the flexible slot or symbol is available. If the value of this bit is 0, it indicates that this part of the flexible slot or symbol is unavailable.

The fifth indication information may be carried on the DCI.

Similar to the method illustrated in FIG. 6, the terminal device illustrated in FIG. 7 may also be an IoT device, and the description of FIG. 6 may be referred to for corresponding features not described in FIG. 7.

The slot configuration information sent by the network device to the IoT device, and the slot configuration information sent to the non-IoT device may be the same, may be different, or may be partially the same. The slot configuration information here may include the slot configuration information sent by the network device through a higher layer signaling, and/or the slot configuration information sent by the network device through the SFI DCI.

For example, the network device can send the same slot configuration information to the IoT device and the non-IoT device through the higher layer signaling and the SFI DCI.

For another example, the network device may send the same slot configuration information to the IoT device and the non-IoT device through the higher layer signaling but send different slot configuration information to the IoT device and the non-IoT device through the SFI DCI.

The network device sending different slot configuration information to the IoT device and the non-IoT device through the SFI DCI may refer to the network device sending different slot configuration information to the IoT device and the non-IoT device respectively through different SFI DCIs. Different SFI DCIs can be represented by PDCCHs carrying SFI DCIs.

In details, the PDCCH carrying the SFI DCI sent by the network device for the IoT device is different from the PDCCH carrying the SFI DCI sent for the non-IoT device in at least one of the followings: a transmission period, a transmission time offset within a period, time domain resources occupied by the PDCCHs, frequency domain resources occupied by the PDCCHs, or a cyclic redundancy check (CRC) scrambled with a radio network temporary identifier (RNTI).

The non-Internet of Things device in this embodiment of the present application may be an eMBB device or a URLLC device.

The set of available slots or symbols indicated by the network device to the IoT device, and the set of available slots or symbols indicated to the non-IoT device may be the same, may be different, or may be partially the same, an embodiment of the present application is not specifically limited.

For example, the available flexible slots or symbols indicated by the network device to the IoT device are different from the available flexible slots or symbols indicated to the non-IoT device. In this way, the restriction of flexible slots or symbols by the IoT device will not have an impact on the IoT device.

As another example, the available flexible slots or symbols indicated by the network device to the IoT device are the same as the available flexible slots or symbols indicated to the non-IoT device. In this way, the network device can send the set of available slots or symbols to the IoT device and the non-IoT device only through one channel and/or one signaling, which can save signaling overhead.

The embodiments of the present application indicate the available flexible slots or symbols through the network device, which not only can effectively limit the set of slots used by the multi-slot PDSCH and the multi-slot PUSCH, but also ensure the flexibility of the network device scheduling. Compared with the method illustrated in FIG. 6, there is no restriction that multi-slot PDSCH and multi-slot PUSCH can only be transmitted in downlink slots and uplink slots. Therefore, the flexibility of the NR slot structure can be ensured, and the resource requirements of multi-slot PDSCH and multi-slot PUSCH transmission of IoT terminals can be met.

Additionally, the network device may indicate to the IoT device that more slots or symbols are available when there is less transmission demand from the non-IoT device. When the transmission demand of the non-IoT device is high, the network device can indicate to the IoT device that fewer available slots will be available. Therefore, the system resources can be fully utilized under the condition that the scheduling resources of the IoT devices and the non-IoT devices are guaranteed not to conflict.

The uplink channel in this embodiment of the present application may include at least one of the followings: PUSCH, PUCCH, and PRACH. The uplink signal may include SRS. The downlink channel may include at least one of the followings: PDSCH and PDCCH.

In this embodiment of the present application, the behavior of the network device is similar to that of the terminal device. Therefore, for methods on the side of the network device that are not described, reference may be made to the method on the side of the terminal device.

In the embodiments of the present application, uplink slots or symbols represent uplink slots or uplink symbols, downlink slots or symbols represent downlink slots or downlink symbols, and flexible slots or symbols represent flexible slots or flexible symbols.

The solution described above is for the slots or symbols in which the terminal device can transmit when the terminal device performs multiple uplink transmissions and/or multiple downlink transmissions. However, the embodiment of the present application may also be applied to one uplink transmission of the terminal device.

For example, if the network device schedules the terminal device to perform uplink transmission once, the terminal device may only perform uplink transmission on the uplink slot or symbol. For another example, if the network device schedules the terminal device to perform downlink transmission once, the terminal device may only perform downlink transmission on downlink slots or symbols. In other words, in some cases, flexible slots or symbols are also not used for a single uplink transmission of the terminal device, and/or a single downlink transmission.

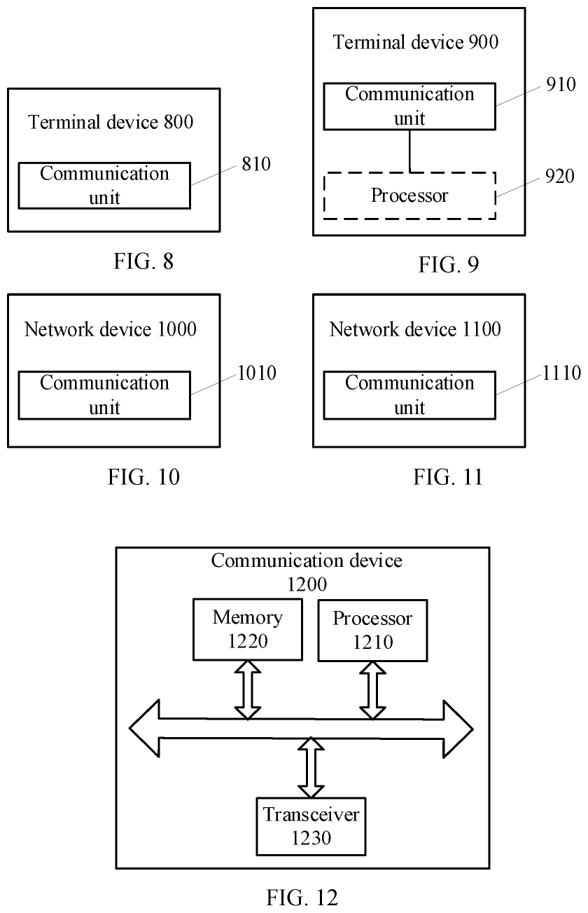

The method for sending release assistance indication information according to an embodiment of the present application is described in detail above. The device according to the embodiments of the present application will be described below with reference to FIG. 8 to FIG. 14, and the technical features described in the method embodiments are applicable to the following device embodiments.

FIG. 8 is a schematic block diagram of a terminal device according to an embodiment of the present application, and the terminal device may be any of the terminal devices described above. The terminal device 800 of FIG. 8 includes a communication unit 810, in which:

The communication unit 810 is configured to: receive a slot configuration information sent by a network device, wherein the slot configuration information is used to indicate at least one of a flexible slot or symbol, an uplink slot or symbol, and a downlink slot or symbol; wherein the flexible slot or symbol is not used by the terminal device to perform multiple uplink transmissions, and/or the flexible slot or symbol is not used by the terminal device to perform multiple downlink transmissions; and the multiple uplink transmissions are same uplink transmissions, and the multiple downlink transmissions are same downlink transmissions.

Optionally, the communication unit 810 is configured to: receive a first indication information sent by the network device, wherein the first indication information is used to instruct a symbol position for the terminal device to perform the uplink transmission; if a symbol position in a first slot corresponding to the first indication information comprises a downlink symbol and/or a flexible symbol indicated by the slot configuration information, or the first slot is a downlink slot and/or a flexible slot, the terminal device does not perform the uplink transmission on the first slot, and/or if a symbol position in a second slot corresponding to the first indication information comprises all uplink symbols, or the second slot is an uplink slot, the terminal device performs the uplink transmission on the second slot.

Optionally, the first indication information is further used to indicate that a number of times of sending the uplink transmission is M times, where M is an integer greater than 1, and the communication unit 810 is configured to: perform the uplink transmission in the uplink slot or symbol until an actual number of times of sending the uplink transmission reaches M times, or perform the uplink transmission in the uplink slot or symbol until a number of consecutive slots that have passed from the first slot indicated by the network device for sending the uplink transmission reaches M.

Optionally, the first indication information is carried in an uplink scheduling grant.

Optionally, the communication unit 810 is configured to: receive a second indication information sent by the network device, wherein the second indication information is used to instruct a symbol position for the terminal device to perform the downlink transmission; if a symbol position in a third slot corresponding to the second indication information comprises an uplink symbol and/or a flexible symbol indicated by the slot configuration information, or the third slot is an uplink slot and/or a flexible slot, the communication unit does not perform the downlink transmission on the third slot, and/or if a symbol position in a fourth slot indicated by the second indication information comprises all downlink symbols, or the fourth slot is a downlink slot, the communication unit performs the downlink transmission on the fourth slot.

Optionally, the second indication information is further used to indicate that a number of times of receiving the downlink transmission is N times, where N is an integer greater than 1, and the communication unit 810 is configured to: perform the downlink transmission in the downlink slot or symbol until an actual number of times of receiving the downlink transmission reaches N times, or perform the downlink transmission in the downlink slot or symbol until a number of consecutive slots that have passed from the first slot indicated by the network device for performing the downlink transmission reaches N.

Optionally, the second indication information is carried in a downlink scheduling grant.

Optionally, the slot configuration information comprises a slot configuration information received by the terminal device through a higher layer signaling and/or a slot format indicator (SFI) downlink control information (DCI).

Optionally, the higher layer signaling comprises a system broadcast message and/or a radio resource control (RRC) signaling.

Optionally, a transmission period of the SFI DCI is greater than or equal to a repetition period of a slot format in the slot configuration information.

Optionally, the slot configuration information included in the SFI DCI is used for the terminal device to determine the slot format before receiving the SFI DCI next time.

Optionally, the terminal device comprises an Internet of Things device or a non-Internet of Things device.

Optionally, the terminal device comprises an Internet of Things device or a non-Internet of Things device, a slot configuration information of the Internet of Things device is same or partially same as a slot configuration information of the non-Internet of Things device, or the slot configuration information of the Internet of Things device is different from the slot configuration information of the non-Internet of Things device.

Optionally, a same part of the slot configuration information of the Internet of Things device and the non-Internet of Things device is received through a broadcast message, and/or different parts of the slot configuration information of the Internet of Things device and the non-Internet of Things device are received through the SFI DCI.

Optionally, the Internet of Things device and the non-Internet of Things device receive different slot configuration information through different SFI DCIs, wherein: PDCCHs carrying the different SFI DCIs are different in at least one of the followings: a transmission period, a transmission time offset within a period, time domain resources occupied by the PDCCHs, frequency domain resources occupied by the PDCCHs, or a cyclic redundancy check (CRC) scrambled with a radio network temporary identifier (RNTI).

Optionally, the non-Internet of Things device is an enhanced mobile broadband (eMBB) device or a ultra reliable low latency communication (URLLC) device.

Optionally, the uplink transmission comprises a transmission of an uplink channel or an uplink signal, and/or the downlink transmission comprises a transmission of a downlink channel or a downlink signal.

Optionally, the uplink channel comprises at least one of the followings: a physical uplink shared channel (PUSCH), a physical uplink control channel (PUCCH), or a physical random access channel (PRACH), and/or the uplink signal comprises a sounding reference signal (SRS), and/or the downlink channel comprises at least one of the followings: a physical downlink shared channel (PDSCH) or a physical downlink control channel (PDCCH).

FIG. 9 is a schematic block diagram of another terminal device according to an embodiment of the present application, and the terminal device may be any of the above-described terminal devices. The terminal device 900 of FIG. 9 includes a communication unit 910, in which:

The communication unit 910 is configured to perform the following operations: receiving a slot configuration information sent by a network device, wherein the slot configuration information is used to indicate at least one of a flexible slot or symbol, an uplink slot or symbol, and a downlink slot or symbol; receiving a first indication information sent by the network device, wherein the first indication information is used to indicate a set of available slots or symbols, and the set of available slots or symbols comprises an available flexible slot or symbol; performing multiple uplink transmissions in a target uplink slot or symbol and the available flexible slot or symbol, and/or performing multiple downlink transmissions in a target downlink slot or symbol and the available flexible slot or symbol; wherein the target uplink slot or symbol is part or all of the uplink slot or symbol indicated by the slot configuration information, the target downlink slot or symbol is part or all of the downlink slot or symbol indicated by the slot configuration information, the multiple uplink transmissions are same uplink transmissions, and the multiple downlink transmissions are same downlink transmissions.

Optionally, the first indication information is further used to indicate an available uplink slot or symbol, and the target uplink slot or symbol is the available uplink slot or symbol.

Optionally, the first indication information is further used to indicate an available downlink slot or symbol, and the target downlink slot or symbol is the available downlink slot or symbol.

Optionally, the communication unit 910 is configured to: receive a second indication information sent by the network device, wherein the second indication information is used to instruct a symbol position for the terminal device to perform the uplink transmission; if a symbol position in a first slot corresponding to the second indication information comprises a symbol that does not belong to a target uplink symbol and an available flexible symbol, the communication unit does not perform the uplink transmission on the first slot, and/or if a symbol position in a second slot corresponding to the second indication information comprises all target uplink symbols and/or available flexible symbols, the communication unit performs the uplink transmission on the second slot.

Optionally, the second indication information is further used to indicate that a number of times of sending the uplink transmission is M times, where M is an integer greater than 1, and the communication unit 910 is configured to: perform the uplink transmission in the target uplink slot or symbol and the available flexible slot or symbol until an actual number of times of sending the uplink transmission reaches M times, or perform the uplink transmission in the target uplink slot or symbol and the available flexible slot or symbol until a number of consecutive slots that have passed from the first slot indicated by the network device for performing the uplink transmission reaches M.

Optionally, the second indication information is carried in an uplink scheduling grant.

Optionally, the communication unit 910 is configured to: receive a third indication information sent by the network device, wherein the third indication information is used to instruct a symbol position for the terminal device to perform the downlink transmission; if a symbol position in a third slot corresponding to the third indication information comprises a symbol that does not belong to a target downlink symbol and an available flexible symbol, the communication unit does not perform the downlink transmission on the third slot, and/or if a symbol position in a fourth slot indicated by the third indication information comprises all target downlink symbols and/or available flexible symbols, the communication unit performs the downlink transmission on the fourth slot.

Optionally, the third indication information is further used to indicate that a number of times of receiving the downlink transmission is N times, where N is an integer greater than 1, and the communication unit 910 is configured to: perform the downlink transmission in the target downlink slot or symbol and the available flexible slot or symbol until an actual number of times of receiving the downlink transmission reaches N times, or perform the downlink transmission in the target downlink slot or symbol and the available flexible slot or symbol until a number of consecutive slots that have passed from the first slot indicated by the network device for performing the downlink transmission reaches N.

Optionally, the third indication information is carried in a downlink scheduling grant.

Optionally, the first indication information is received by the terminal device through a higher layer signaling and/or a downlink control information (DCI).

Optionally, the first indication information is used to indicate an index of the set of available slots or symbols, and the terminal device further comprises a processor configured to: determine the set of available slots or symbols according to the index of the set of available slots or symbols.

Optionally, the communication unit 910 is configured to: receive a configuration information of at least one set of slots or symbols and an index of the at least one set of slots or symbols sent by the network device, wherein the at least one set of slots or symbols comprises a set of available slots or symbols.

Optionally, the set of available slots or symbols is indicated by means of a bitmap.

Optionally, one bit in the bitmap is used to indicate whether one slot or symbol is available, or one bit in the bitmap is used to indicate whether multiple slots or symbols are available.

Optionally, the communication unit 910 is configured to: receive a fourth indication information sent by the network device, wherein the fourth indication information is used to indicate whether the flexible slot or symbol indicated by the slot configuration information is available.

Optionally, the fourth indication information uses one bit to indicate whether the flexible slot or symbol indicated by the slot configuration information is available.

Optionally, the communication unit 910 is configured to: receive a fifth indication information sent by the network device, wherein the fifth indication information is used to indicate whether a part of the flexible slot or symbol indicated by the slot configuration information is available, and the part of the flexible slot or symbol is configured by the network device to the terminal device through a higher layer signaling.

Optionally, the fifth indication information uses one bit to indicate whether the part of the flexible slot or symbol indicated by the slot configuration information is available.

Optionally, the fourth indication information is carried in a downlink control information (DCI), and/or the fifth indication information is carried in the DCI.

Optionally, the terminal device comprises an Internet of Things device or a non-Internet of Things device.

Optionally, the terminal device comprises an Internet of Things device or a non-Internet of Things device, a slot configuration information of the Internet of Things device is same or partially same as a slot configuration information of the non-Internet of Things device, or the slot configuration information of the Internet of Things device is different from the slot configuration information of the non-Internet of Things device.

Optionally, a same part of the slot configuration information of the Internet of Things device and the non-Internet of Things device is received through a broadcast message, and/or different parts of the slot configuration information of the Internet of Things device and the non-Internet of Things device are received through a slot format indicator (SFI) DCI.

Optionally, the Internet of Things device and the non-Internet of Things device receive different slot configuration information through different SFI DCIs, PDCCHs carrying the different SFI DCIs are different in at least one of the followings: a transmission period, a transmission time offset within a period, time domain resources occupied by the PDCCHs, frequency domain resources occupied by the PDCCHs, or a cyclic redundancy check (CRC) scrambled with a radio network temporary identifier (RNTI).

Optionally, the non-Internet of Things device is an enhanced mobile broadband (eMBB) device or a ultra reliable low latency communication (URLLC) device.

Optionally, the terminal device comprises an Internet of Things device or a non-Internet of Things device, a set of available slots or symbols of the Internet of Things device and a set of available slots or symbols of the non-Internet of Things device are same or partially same, or the set of available slots or symbols of the Internet of Things device and the set of available slots or symbols of the non-Internet of Things device are different.

Optionally, the uplink transmission comprises a transmission of an uplink channel or an uplink signal, and/or the downlink transmission comprises a transmission of a downlink channel or a downlink signal.

Optionally, the uplink channel comprises at least one of the followings: a physical uplink shared channel (PUSCH), a physical uplink control channel (PUCCH), or a physical random access channel (PRACH), and/or the uplink signal comprises a sounding reference signal (SRS), and/or the downlink channel comprises at least one of the followings: a physical downlink shared channel (PDSCH) or a physical downlink control channel (PDCCH).

FIG. 10 is a schematic block diagram of a network device according to an embodiment of the present application, and the network device may be any of the network devices described above. The network device 1000 of FIG. 10 includes a communication unit 1010, wherein:

The communication unit 1010 is configured to perform the following operations: sending a slot configuration information to a terminal device, wherein the slot configuration information is used to indicate at least one of a flexible slot or symbol, an uplink slot or symbol, and a downlink slot or symbol; wherein the flexible slot or symbol is not used by the terminal device to perform multiple uplink transmissions, and/or the flexible slot or symbol is not used by the terminal device to perform multiple downlink transmissions; and the multiple uplink transmissions are same uplink transmissions, and the multiple downlink transmissions are same downlink transmissions.

Optionally, the communication unit 1010 is configured to: send a first indication information to the terminal device, wherein the first indication information is used to instruct a symbol position for the terminal device to perform the uplink transmission; if a symbol position in a first slot corresponding to the first indication information comprises a downlink symbol and/or a flexible symbol indicated by the slot configuration information, or the first slot is a downlink slot and/or a flexible slot, the communication unit does not perform the uplink transmission on the first slot, and/or if a symbol position in a second slot corresponding to the first indication information comprises all uplink symbols, or the second slot is an uplink slot, the communication unit performs the uplink transmission on the second slot.

Optionally, the first indication information is further used to indicate that a number of times of sending the uplink transmission is M times, where M is an integer greater than 1, and the communication unit 1010 is configured to: perform the uplink transmission in the uplink slot or symbol until an actual number of times of receiving the uplink transmission reaches M times, or perform the uplink transmission in the uplink slot or symbol until a number of consecutive slots that have passed from the first slot indicated by the network device for the terminal device performing the uplink transmission reaches M.

Optionally, the first indication information is carried in an uplink scheduling grant.

Optionally, the communication unit 1010 is configured to: send a second indication information to the terminal device, wherein the second indication information is used to instruct a symbol position for the terminal device to perform the downlink transmission; if a symbol position in a third slot corresponding to the second indication information comprises an uplink symbol and/or a flexible symbol indicated by the slot configuration information, or the third slot is an uplink slot and/or a flexible slot, the communication unit does not perform the downlink transmission on the third slot, and/or if a symbol position in a fourth slot indicated by the second indication information comprises all downlink symbols, or the fourth slot is a downlink slot, the communication unit performs the downlink transmission on the fourth slot.

Optionally, the second indication information is further used to indicate that a number of times of receiving the downlink transmission is N times, where N is an integer greater than 1, and the communication unit 1010 is configured to: perform the downlink transmission in the downlink slot or symbol until an actual number of times of sending the downlink transmission reaches N times, or perform the downlink transmission in the downlink slot or symbol until a number of consecutive slots that have passed from the first slot indicated by the network device for the terminal device performing the downlink transmission reaches N.

Optionally, the second indication information is carried in a downlink scheduling grant.

Optionally, the slot configuration information comprises a slot configuration information sent by the network device to the terminal device through a higher layer signaling and/or a slot format indicator (SFI) downlink control information (DCI).

Optionally, the higher layer signaling comprises a system broadcast message and/or a radio resource control (RRC) signaling.

Optionally, a transmission period of the SFI DCI is greater than or equal to a repetition period of a slot format in the slot configuration information.

Optionally, the slot configuration information included in the SFI DCI is used for the terminal device to determine the slot format before receiving the SFI DCI next time.

Optionally, the terminal device comprises an Internet of Things device or a non-Internet of Things device.

Optionally, the terminal device comprises an Internet of Things device or a non-Internet of Things device, a slot configuration information of the Internet of Things device and a slot configuration information of the non-Internet of Things device sent by the network device to the terminal device are same or partially same, or the slot configuration information of the Internet of Things device and the slot configuration information of the non-Internet of Things device by the network device to the terminal device are different.

Optionally, the same slot configuration information of the Internet of Things device and the non-Internet of Things device is sent by the network device through a broadcast message, and/or the different slot configuration information of the Internet of Things device and the non-Internet of Things device is sent by the network device through the SFI DCI.

Optionally, the network device sends the different slot configuration information to the Internet of Things device and the non-Internet of Things device through different SFI DCIs, wherein: PDCCHs carrying the different SFI DCIs are different in at least one of the followings: a transmission period, a transmission time offset within a period, time domain resources occupied by the PDCCHs, frequency domain resources occupied by the PDCCHs, or a cyclic redundancy check (CRC) scrambled with a radio network temporary identifier (RNTI).

Optionally, the non-Internet of Things device is an enhanced mobile broadband (eMBB) device or a ultra reliable low latency communication (URLLC) device.

Optionally, the uplink transmission comprises a transmission of an uplink channel or an uplink signal, and/or the downlink transmission comprises a transmission of a downlink channel or a downlink signal.

Optionally, the uplink channel comprises at least one of the followings: a physical uplink shared channel (PUSCH), a physical uplink control channel (PUCCH), or a physical random access channel (PRACH), and/or the uplink signal comprises a sounding reference signal (SRS), and/or the downlink channel comprises at least one of the followings: a physical downlink shared channel (PDSCH) or a physical downlink control channel (PDCCH).

FIG. 11 is a schematic block diagram of another network device according to an embodiment of the present application, and the network device may be any of the network devices described above. The network device 1100 of FIG. 11 includes a communication unit 1110, wherein:

The communication unit 1110 is configured to perform the following operations: sending a slot configuration information to a terminal device, wherein the slot configuration information is used to indicate at least one of a flexible slot or symbol, an uplink slot or symbol, and a downlink slot or symbol; sending a first indication information to the terminal device, wherein the first indication information is used to indicate a set of available slots or symbols, and the set of available slots or symbols comprises an available flexible slot or symbol; performing multiple uplink transmissions in a target uplink slot or symbol and the available flexible slot or symbol indicated by the slot configuration information, and/or performing multiple downlink transmissions in a target downlink slot or symbol and the available flexible slot or symbol indicated by the slot configuration information, wherein the target uplink slot or symbol is part or all of the uplink slot or symbol indicated by the slot configuration information, the target downlink slot or symbol is part or all of the downlink slot or symbol indicated by the slot configuration information, wherein the multiple uplink transmissions are same uplink transmissions, and the multiple downlink transmissions are same downlink transmissions.

Optionally, the first indication information is further used to indicate an available uplink slot or symbol, and the target uplink slot or symbol is the available uplink slot or symbol.

Optionally, the first indication information is further used to indicate an available downlink slot or symbol, and the target downlink slot or symbol is the available downlink slot or symbol.

Optionally, the communication unit 1110 is configured to: send a second indication information to the terminal device, wherein the second indication information is used to instruct a symbol position for the terminal device to perform the uplink transmission; if a symbol position in a first slot corresponding to the second indication information comprises a symbol that does not belong to a target uplink symbol and an available flexible symbol, the communication unit does not perform the uplink transmission on the first slot, and/or if a symbol position in a second slot corresponding to the second indication information comprises all target uplink symbols and/or available flexible symbols, the communication unit performs the uplink transmission on the second slot.

Optionally, the second indication information is further used to indicate that a number of times of sending the uplink transmission is M times, where M is an integer greater than 1, and the communication unit 1110 is configured to: perform the uplink transmission in the target uplink slot or symbol and the available flexible slot or symbol until an actual number of times of sending the uplink transmission reaches M times, or perform the uplink transmission in the target uplink slot or symbol and the available flexible slot or symbol until a number of consecutive slots that have passed from the first slot indicated by the network device for the terminal device performing the uplink transmission reaches M.

Optionally, the second indication information is carried in an uplink scheduling grant.

Optionally, the communication unit 1110 is configured to: send a third indication information to the terminal device, wherein the third indication information is used to instruct a symbol position for the terminal device to perform the downlink transmission; if a symbol position in a third slot corresponding to the third indication information comprises a symbol that does not belong to a target downlink symbol and an available flexible symbol, the communication unit does not perform the downlink transmission on the third slot, and/or if a symbol position in a fourth slot indicated by the third indication information comprises all target downlink symbols and/or available flexible symbols, the communication unit performs the downlink transmission on the fourth slot.

Optionally, the third indication information is further used to indicate that a number of times of receiving the downlink transmission is N times, where N is an integer greater than 1, and the communication unit 1110 is configured to: perform the downlink transmission in the target downlink slot or symbol and the available flexible slot or symbol until an actual number of times of receiving the downlink transmission reaches N times, or perform the downlink transmission in the target downlink slot or symbol and the available flexible slot or symbol until a number of consecutive slots that have passed from the first slot indicated by the network device for the terminal device performing the downlink transmission reaches N.

Optionally, the third indication information is carried in a downlink scheduling grant.

Optionally, the first indication information is received by the terminal device through a higher layer signaling and/or a downlink control information (DCI).

Optionally, the first indication information is used to indicate an index of the set of available slots or symbols.

Optionally, the communication unit 1110 is configured to: send a configuration information of at least one set of slots or symbols and an index of the at least one set of slots or symbols to the terminal device, wherein the at least one set of slots or symbols comprises a set of available slots or symbols.

Optionally, the set of available slots or symbols is indicated by means of a bitmap.

Optionally, one bit in the bitmap is used to indicate whether one slot or symbol is available, or one bit in the bitmap is used to indicate whether multiple slots or symbols are available.

Optionally, the communication unit 1110 is configured to: send a fourth indication information to the terminal device, wherein the fourth indication information is used to indicate whether the flexible slot or symbol indicated by the slot configuration information is available.

Optionally, the fourth indication information uses one bit to indicate whether the flexible slot or symbol indicated by the slot configuration information is available.

Optionally, the communication unit 1110 is configured to: send a fifth indication information to the terminal device, wherein the fifth indication information is used to indicate whether a part of the flexible slot or symbol indicated by the slot configuration information is available, and the part of the flexible slot or symbol is configured by the network device to the terminal device through a higher layer signaling.

Optionally, the fifth indication information uses one bit to indicate whether the part of the flexible slot or symbol indicated by the slot configuration information is available.

Optionally, the fourth indication information is carried in a downlink control information (DCI), and/or the fifth indication information is carried in the DCI.

Optionally, the terminal device comprises an Internet of Things device or a non-Internet of Things device.

Optionally, the terminal device comprises an Internet of Things device or a non-Internet of Things device, a slot configuration information of the Internet of Things device and a slot configuration information of the non-Internet of Things device sent by the network device to the terminal device are same or partially same, or the slot configuration information of the Internet of Things device and the slot configuration information of the non-Internet of Things device by the network device to the terminal device are different.

Optionally, the same slot configuration information of the Internet of Things device and the non-Internet of Things device is sent by the network device through a broadcast message, and/or the different slot configuration information of the Internet of Things device and the non-Internet of Things device is sent by the network device through a slot format indicator (SFI) DCI.

Optionally, the Internet of Things device and the non-Internet of Things device receive different slot configuration information through different SFI DCIs, wherein PDCCHs carrying the different SFI DCIs are different in at least one of the followings: a transmission period, a transmission time offset within a period, time domain resources occupied by the PDCCHs, frequency domain resources occupied by the PDCCHs, or a cyclic redundancy check (CRC) scrambled with a radio network temporary identifier (RNTI).

Optionally, the non-Internet of Things device is an enhanced mobile broadband (eMBB) device or a ultra reliable low latency communication (URLLC) device.

Optionally, the terminal device comprises an Internet of Things device or a non-Internet of Things device, a set of available slots or symbols of the Internet of Things device and a set of available slots or symbols of the non-Internet of Things device sent by the network device are same or partially same, or the set of available slots or symbols of the Internet of Things device and the set of available slots or symbols of the non-Internet of Things device sent by the network device are different.

Optionally, the uplink transmission comprises a transmission of an uplink channel or an uplink signal, and/or the downlink transmission comprises a transmission of a downlink channel or a downlink signal.

Optionally, the uplink channel comprises at least one of the followings: a physical uplink shared channel (PUSCH), a physical uplink control channel (PUCCH), or a physical random access channel (PRACH), and/or the uplink signal comprises a sounding reference signal (SRS), and/or the downlink channel comprises at least one of the followings: a physical downlink shared channel (PDSCH) or a physical downlink control channel (PDCCH).

FIG. 12 is a schematic structure diagram of a communication device 1200 according to an embodiment of the present application. The communication device 1200 illustrated in FIG. 12 includes a processor 1210, and the processor 1210 may call and run a computer program in a memory to implement the method in the embodiments of the present application.

Optionally, as illustrated in FIG. 12, the communication device 1200 may further include the memory 1220. The processor 1210 may call and run the computer program in the memory 1220 to implement the method in the embodiments of the present application.

The memory 1220 may be an independent device independent of the processor 1210 and may also be integrated into the processor 1210.

Optionally, as illustrated in FIG. 12, the communication device 1200 may further include a transceiver 1230, and the processor 1210 may control the transceiver 1230 to communicate with another device, specifically sending information or data to the other device or receiving information or data from the other device.

The transceiver 1230 may include a transmitter and a receiver. The transceiver 1230 may further include antennae. The number of the antennae may be one or more.

Optionally, the communication device 1200 may specifically be the network device of the embodiments of the present application. The communication device 1200 may implement corresponding flows implemented by the network device in each method of the embodiments of the present application. For simplicity, elaborations are omitted herein.

Optionally, the communication device 1200 may specifically be the mobile terminal/terminal device of the embodiments of the present application. The communication device 1200 may implement the corresponding flows implemented by the mobile terminal/terminal device in each method of the embodiments of the present application. For simplicity, elaborations are omitted herein.

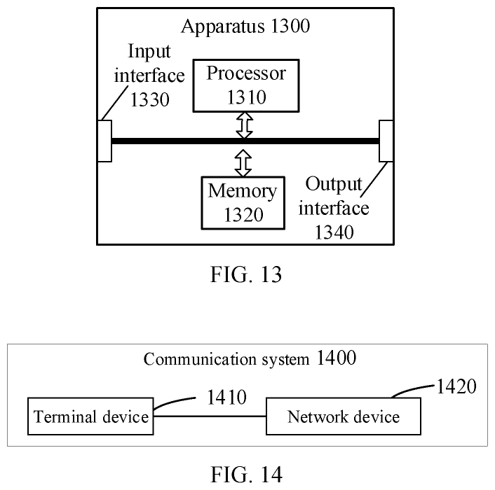

FIG. 13 is a schematic structure diagram of an apparatus according to another embodiment of the present application. The apparatus 1300 illustrated in FIG. 13 includes a processor 1310. The processor 1310 may call and run a computer program in a memory to implement the method in the embodiments of the present application.

Optionally, as illustrated in FIG. 13, the apparatus 1300 may further include the memory 1320. The processor 1310 may call and run the computer program in the memory 1320 to implement the method in the embodiments of the present application.

The memory 1320 may be an independent device independent of the processor 1313 and may also be integrated into the processor 1310.

Optionally, the apparatus 1300 may further include an input interface 1330. The processor 1310 may control the input interface 1330 to communicate with another device or apparatus, specifically acquiring information or data from the another device or apparatus.

Optionally, the apparatus 1300 may further include an output interface 1340. The processor 1310 may control the output interface 1340 to communicate with another device or apparatus, specifically outputting information or data sent by the another device or apparatus.

Optionally, the apparatus may be applied to the network device of the embodiments of the present application. The apparatus may implement corresponding flows implemented by the network device in each method of the embodiments of the present application. For simplicity, elaborations are omitted herein.

Optionally, the apparatus may be applied to the mobile terminal/terminal device of the embodiment of the present application. The apparatus may implement corresponding flows implemented by the mobile terminal/terminal device in each method of the embodiment of the present application. For simplicity, elaborations are omitted herein.

It is to be understood that the apparatus mentioned in the embodiment of the present application may be a chip. The chip may also be called a system-level chip, a system chip, a chip system, or a system on chip, etc.

FIG. 14 is a second block diagram of a communication system 1400 according to an embodiment of the present application. As illustrated in FIG. 14, a communication system 1400 includes a terminal device 1410 and a network device 1420.

The terminal device 1410 may be configured to realize corresponding functions realized by the terminal device in the method. The network device 1420 may be configured to realize corresponding functions realized by the network device in the method. For simplicity, elaborations are omitted herein.

It is to be understood that the processor in the embodiment of the present application may be an integrated circuit chip and has a signal processing capacity. In an implementation process, each step of the method embodiments may be completed by an integrated logical circuit of hardware in the processor or an instruction in a software form. The processor may be a universal processor, a digital signal processor (DSP), an application specific integrated circuit (ASIC), a field programmable gate array (FPGA) or another programmable logical device, discrete gate or transistor logical device and discrete hardware component. Each method, step and logical block diagram disclosed in the embodiments of the present application may be implemented or executed. The universal processor may be a microprocessor or the processor may also be any conventional processor and the like. The steps of the method disclosed in combination with the embodiments of the present application may be directly embodied to be executed and completed by a hardware decoding processor or executed and completed by a combination of hardware and software modules in the decoding processor. The software module may be located in a mature storage medium in this field such as a random access memory (RAM), a flash memory, a read-only memory (ROM), a programmable ROM (PROM) or electrically erasable PROM (EEPROM) and a register. The storage medium is located in a memory, and the processor reads information in the memory, and completes the steps of the method in combination with hardware.

It can be understood that the memory in the embodiment of the present application may be a volatile memory or a nonvolatile memory, or may include both the volatile and nonvolatile memories. The nonvolatile memory may be a ROM, a PROM, an erasable PROM (EPROM), an EEPROM or a flash memory. The volatile memory may be a RAM and is used as an external high-speed cache. It is exemplarily but unlimitedly described that RAMs in various forms may be adopted, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM) and a direct rambus RAM (DR RAM). It is to be noted that the memory of a system and method described in the present application is intended to include, but not limited to, memories of these and any other proper types.

It is to be understood that the memory is exemplarily but unlimitedly described. For example, the memory in the embodiments of the present application may also be an SRAM, a DRAM, an SDRAM, a DDR SDRAM, an ESDRAM, an SLDRAM and a DR RAM. That is, the memory in the embodiments of the present application is intended to include, but not limited to, memories of these and any other proper types.

The embodiments of the present application also provide a computer-readable storage medium, which is configured to store a computer program.

Optionally, the computer-readable storage medium may be applied to a network device in the embodiments of the present application. The computer program causes a computer to execute corresponding flows implemented by the network device in each method of the embodiments of the present application. For simplicity, elaborations are omitted herein.

Optionally, the computer-readable storage medium may be applied to a mobile terminal/terminal device in the embodiments of the present application. The computer program causes a computer to execute corresponding flows implemented by the mobile terminal/terminal device in each method of the embodiments of the present application. For simplicity, elaborations are omitted herein.

The embodiments of the present application also provide a computer program product, which includes a computer program instruction.

Optionally, the computer program product may be applied to a network device in the embodiments of the present application. The computer program instruction causes a computer to execute corresponding flows implemented by the network device in each method of the embodiments of the present application. For simplicity, elaborations are omitted herein.

Optionally, the computer program product may be applied to a mobile terminal/terminal device in the embodiments of the present application. The computer program instruction causes the computer to execute corresponding flows implemented by the mobile terminal/terminal device in each method of the embodiments of the present application. For simplicity, elaborations are omitted herein.

The embodiments of the present application also provide a computer program.

Optionally, the computer program may be applied to a network device in the embodiments of the present application. The computer program runs in a computer to cause the computer to execute corresponding flows implemented by the network device in each method of the embodiments of the present application. For simplicity, elaborations are omitted herein.

Optionally, the computer program may be applied to a mobile terminal/terminal device in the embodiments of the present application. The computer program runs in the computer to cause the computer to execute corresponding flows implemented by the mobile terminal/terminal device in each method of the embodiments of the present application. For simplicity, elaborations are omitted herein.

Those of ordinary skill in the art may realize that the units and algorithm steps of each example described in combination with the embodiments disclosed in the present application may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the present application.

Those skilled in the art may clearly learn about that specific working processes of the system, device and unit described above may refer to the corresponding processes in the method embodiment and will not be elaborated herein for convenient and brief description.

In some embodiments provided by the present application, it is to be understood that the disclosed system, device and method may be implemented in another manner.

For example, the device embodiment described above is only schematic, and for example, division of the units is only logic function division, and other division manners may be adopted during practical implementation.

For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated. Parts displayed as units may or may not be physical units, and namely may be located in the same place, or may also be distributed to multiple network units. Part or all of the units may be selected to achieve the solutions of the embodiments according to a practical requirement.

In addition, each functional unit in each embodiment of the present application may be integrated into a processing unit. Each unit may also physically exist independently. Two or more than two units may also be integrated into a unit.

When being realized in form of software functional unit and sold or used as an independent product, the function may also be stored in a computer-readable storage medium. For such an understanding, the technical solutions of the present application substantially or parts making contributions to the conventional art or part of the technical solutions may be embodied in form of software product. The computer software product may be stored in a storage medium, including a plurality of instructions configured to cause a computer device (which may be a personal computer, a server, a network device or the like) to execute all or part of the steps of the method in each embodiment of the present application. The abovementioned storage medium includes: various media capable of storing program codes such as a U disk, a mobile hard disk, a ROM, a RAM, a magnetic disk or an optical disk.

The above is only the specific implementation mode of the present application and not intended to limit the scope of protection of the present application. Any variations or replacements apparent to those skilled in the art within the technical scope disclosed by the present application shall fall within the scope of protection of the present application. Therefore, the scope of protection of the present application shall be subject to the scope of protection of the claims.

What is claimed is:

1. A wireless communication method, comprising:
a terminal device receiving a slot configuration information sent by a network device, wherein the slot configuration information is used to indicate at least one of a flexible slot or symbol, an uplink slot or symbol, and a downlink slot or symbol;
wherein the flexible slot or symbol is not used by the terminal device to perform multiple uplink transmissions, and/or the flexible slot or symbol is not used by the terminal device to perform multiple downlink transmissions; and the multiple uplink transmissions are same uplink transmissions, and the multiple downlink transmissions are same downlink transmissions.

2. The method according to claim 1, wherein the method further comprises:
the terminal device receiving a first indication information sent by the network device, wherein the first indication information is used to instruct a symbol position for the terminal device to perform the uplink transmission;
if a symbol position in a first slot corresponding to the first indication information comprises a downlink symbol and/or a flexible symbol indicated by the slot configuration information, or the first slot is a downlink slot and/or a flexible slot, the terminal device does not perform the uplink transmission on the first slot, and/or
if a symbol position in a second slot corresponding to the first indication information comprises all uplink symbols, or the second slot is an uplink slot, the terminal device performs the uplink transmission on the second slot.

3. The method according to claim 2, wherein the first indication information is further used to indicate that a number of times of sending the uplink transmission is M times, where M is an integer greater than 1, and the method further comprises:
the terminal device performing the uplink transmission in the uplink slot or symbol until an actual number of times of sending the uplink transmission reaches M times, or
the terminal device performing the uplink transmission in the uplink slot or symbol until a number of consecutive slots that have passed from the first slot indicated by the network device for sending the uplink transmission reaches M.

4. The method according to claim 2, wherein the first indication information is carried in an uplink scheduling grant.

5. The method according to claim 1, wherein the method further comprises:
the terminal device receiving a second indication information sent by the network device, wherein the second indication information is used to instruct a symbol position for the terminal device to perform the downlink transmission;
if a symbol position in a third slot corresponding to the second indication information comprises an uplink symbol and/or a flexible symbol indicated by the slot configuration information, or the third slot is an uplink slot and/or a flexible slot, the terminal device does not perform the downlink transmission on the third slot, and/or
if a symbol position in a fourth slot indicated by the second indication information comprises all downlink symbols, or the fourth slot is a downlink slot, the terminal device performs the downlink transmission on the fourth slot.

6. The method according to claim 5, wherein the second indication information is further used to indicate that a number of times of receiving the downlink transmission is N times, where N is an integer greater than 1, and the method further comprises:
the terminal device performing the downlink transmission in the downlink slot or symbol until an actual number of times of receiving the downlink transmission reaches N times, or
the terminal device performing the downlink transmission in the downlink slot or symbol until a number of consecutive slots that have passed from the first slot indicated by the network device for performing the downlink transmission reaches N.

7. The method according to claim 5, wherein the second indication information is carried in a downlink scheduling grant.

8. The method according to claim 1, wherein the slot configuration information comprises a slot configuration information received by the terminal device through a higher layer signaling and/or a slot format indicator (SFI) downlink control information (DCI).

9. A wireless communication method, comprising:
a network device sending a slot configuration information to a terminal device, wherein the slot configuration information is used to indicate at least one of a flexible slot or symbol, an uplink slot or symbol, and a downlink slot or symbol;
wherein the flexible slot or symbol is not used by the terminal device to perform multiple uplink transmissions, and/or the flexible slot or symbol is not used by the terminal device to perform multiple downlink transmissions; and the multiple uplink transmissions are same uplink transmissions, and the multiple downlink transmissions are same downlink transmissions.

10. The method according to claim 9, wherein the method further comprises:
the network device sending a first indication information to the terminal device, wherein the first indication information is used to instruct a symbol position for the terminal device to perform the uplink transmission;
if a symbol position in a first slot corresponding to the first indication information comprises a downlink symbol and/or a flexible symbol indicated by the slot configuration information, or the first slot is a downlink slot and/or a flexible slot, the network device does not perform the uplink transmission on the first slot, and/or
if a symbol position in a second slot corresponding to the first indication information comprises all uplink symbols, or the second slot is an uplink slot, the network device performs the uplink transmission on the second slot.

11. The method according to claim 10, wherein the first indication information is further used to indicate that a number of times of sending the uplink transmission is M times, where M is an integer greater than 1, and the method further comprises:
the network device performing the uplink transmission in the uplink slot or symbol until an actual number of times of receiving the uplink transmission reaches M times, or
the network device performing the uplink transmission in the uplink slot or symbol until a number of consecutive slots that have passed from the first slot indicated by the network device for the terminal device performing the uplink transmission reaches M.

12. The method according to claim 10, wherein the first indication information is carried in an uplink scheduling grant.

13. The method according to claim 9, wherein the method further comprises:
the network device sending a second indication information to the terminal device, wherein the second indication information is used to instruct a symbol position for the terminal device to perform the downlink transmission;
if a symbol position in a third slot corresponding to the second indication information comprises an uplink symbol and/or a flexible symbol indicated by the slot configuration information, or the third slot is an uplink slot and/or a flexible slot, the network device does not perform the downlink transmission on the third slot, and/or
if a symbol position in a fourth slot indicated by the second indication information comprises all downlink symbols, or the fourth slot is a downlink slot, the network device performs the downlink transmission on the fourth slot.

14. The method according to claim 13, wherein the second indication information is further used to indicate that a number of times of receiving the downlink transmission is N times, where N is an integer greater than 1, and the method further comprises:
the network device performing the downlink transmission in the downlink slot or symbol until an actual number of times of sending the downlink transmission reaches N times, or
the network device performing the downlink transmission in the downlink slot or symbol until a number of consecutive slots that have passed from the first slot indicated by the network device for the terminal device performing the downlink transmission reaches N.

15. The method according to claim 13, wherein the second indication information is carried in a downlink scheduling grant.

16. The method according to claim 9, wherein the slot configuration information comprises a slot configuration information sent by the network device to the terminal device through a higher layer signaling and/or a slot format indicator (SFI) downlink control information (DCI).

17. A terminal device, comprising:
a communication unit configured to receive a slot configuration information sent by a network device, wherein the slot configuration information is used to indicate at least one of a flexible slot or symbol, an uplink slot or symbol, and a downlink slot or symbol;
wherein the flexible slot or symbol is not used by the terminal device to perform multiple uplink transmissions, and/or the flexible slot or symbol is not used by the terminal device to perform multiple downlink transmissions; and the multiple uplink transmissions are same uplink transmissions, and the multiple downlink transmissions are same downlink transmissions.

18. The terminal device according to claim 17, wherein the communication unit is configured to:
receive a first indication information sent by the network device, wherein the first indication information is used to instruct a symbol position for the terminal device to perform the uplink transmission;
if a symbol position in a first slot corresponding to the first indication information comprises a downlink symbol and/or a flexible symbol indicated by the slot configuration information, or the first slot is a downlink slot and/or a flexible slot, the terminal device does not perform the uplink transmission on the first slot, and/or
if a symbol position in a second slot corresponding to the first indication information comprises all uplink symbols, or the second slot is an uplink slot, the terminal device performs the uplink transmission on the second slot.

19. The terminal device according to claim 18, wherein the first indication information is further used to indicate that a number of times of sending the uplink transmission is M times, where M is an integer greater than 1, and the communication unit is configured to:
perform the uplink transmission in the uplink slot or symbol until an actual number of times of sending the uplink transmission reaches M times, or
perform the uplink transmission in the uplink slot or symbol until a number of consecutive slots that have passed from the first slot indicated by the network device for sending the uplink transmission reaches M.

20. The terminal device according to claim 18, wherein the first indication information is carried in an uplink scheduling grant.
